(19) United States
(12) Patent Application Publication
(10) Pub. No.: US 2009/0122236 A1
(43) Pub. Date: May 14, 2009

(54) POLARIZING PLATE WITH AN OPTICAL COMPENSATION LAYER AND IMAGE DISPLAY APPARATUS USING THE SAME

(75) Inventors: Shunsuke Shutou, Osaka (JP); Yusuke Toyama, Osaka (JP); Nobuyuki Kozonoi, Osaka (JP); Tatsuya Osuka, Osaka (JP); Naoki Takahashi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/090,770

(22) PCT Filed: Oct. 11, 2006
(86) PCT No.: PCT/JP2006/320263

§ 371 Date: Jan. 7, 2009

(30) Foreign Application Priority Data
Oct. 21, 2005 (JP) 2005-306937

(51) Int. Cl. G02F 1/1335; G02B 1/08; G02B 5/30

(52) U.S. Cl. 349/96; 359/500; 359/499

(57) ABSTRACT

There are provided a polarizing plate with an optical compensation layer capable of suppressing the degradation in optical properties due to the use under a high-temperature environment, and an image display apparatus using the polarizing plate with an optical compensation layer.

The polarizing plate with an optical compensation layer includes a polarizer, a pressure-sensitive adhesive layer and at least one optical compensation layer, in the stated order. The pressure-sensitive adhesive layer has a dynamic storage shear modulus (G′) at 100° C. of 1.0×10⁴ to 6.0×10⁴ Pa.

### TECHNICAL FIELD

The present invention relates to a polarizing plate with an optical compensation layer and an image display apparatus using the same. More specifically, the present invention relates to a polarizing plate with an optical compensation layer capable of suppressing the degradation in optical properties due to the use under high-temperature environment and to an image display apparatus using the polarizing plate with an optical compensation layer.

### BACKGROUND ART

As a liquid crystal display apparatus of a VA mode, a semi-transmission reflection-type liquid crystal display apparatus has been proposed in addition to a transmission-type liquid crystal display apparatus and a reflection-type liquid crystal display apparatus (for example, see Patent Documents 1 and 2). The semi-transmission reflection-type liquid crystal display apparatus enables a display to be recognized visually by using ambient light in a light place in the same way as in the reflection-type liquid crystal display apparatus, and using an internal light source such as a backlight in a dark place. In other words, the semi-transmission reflection-type liquid crystal display apparatus employs a display system that has both a reflection-type and a transmission-type, and switches a display mode between a reflection mode and a transmission mode depending upon the ambient brightness. As a result, the semi-transmission reflection-type liquid crystal display apparatus can perform a clear display even in a dark place with the reduction of the power consumption. Therefore, the semi-transmission reflection-type liquid crystal display apparatus can be used preferably for a display part of mobile equipment, for instance.

A specific example of such a semi-transmission reflection-type liquid crystal display apparatus includes a liquid crystal display apparatus that includes a reflective film, which is obtained by forming a window portion for transmitting light on a film made of metal such as aluminum, on an inner side of a lower substrate, and allows the reflective film to function as a semi-transmission reflection plate. In the liquid crystal display apparatus described above, in the case of the reflection mode, ambient light entered from an upper substrate side passes through a liquid crystal layer, is reflected by the reflective film on the inner side of the lower substrate, passes through the liquid crystal layer again, and outgoes from an upper substrate side, thereby contributing to a display. On the other hand, in the case of transmission mode, light from the backlight entered from the lower substrate side passes through the liquid crystal layer through the window portion of the reflective film, and outgoes from the upper substrate side, thereby contributing to a display. Thus, in a region where the reflective film is formed, a region in which the window portion is formed functions as a transmission display region, and the other region functions as a reflection display region.

In the conventional reflection-type or semi-transmission reflection-type liquid crystal display apparatus of a VA mode, the problem in that light leakage occurs in a black display to cause a problem of degradation of a contrast, which has not been overcome for a long time. As means for solving such a problem, a polarizing plate with an optical compensation layer in which a polarizer and an optical compensation layer are laminated has been proposed (for example, see Patent Document 3).

However, the above polarizing plate with an optical compensation layer has a problem in that optical properties are degraded during the use under a high-temperature environment.

### Patent Document 1: JP 11-242226 A

### Patent Document 2: JP 2001-209065 A

### Patent Document 3: JP 2005-070098 A

### DISCLOSURE OF THE INVENTION

### Problems to be Solved by the Invention

The present invention has been made in view of solving the above conventional problem, and an object of the present invention is to provide a polarizing plate with an optical compensation layer capable of suppressing the degradation in optical properties due to the use under a high-temperature environment, and an image display apparatus using the polarizing plate with an optical compensation layer.

### Means for Solving the Problems

According to one aspect of the invention, a polarizing plate with an optical compensation layer is provided. The polarizing plate with an optical compensation layer includes a polarizer, a pressure-sensitive adhesive layer and at least one optical compensation layer, in the stated order. The pressure-sensitive adhesive layer has a dynamic storage shear modulus (G′) at 100° C. of 1.0×10⁴ to 6.0×10⁴ Pa.

In one embodiment of the invention, the at least one optical compensation layer includes a first optical compensation layer, a second optical compensation layer, and a third optical compensation layer in the stated order. The first optical compensation layer contains a resin having an absolute value of a photoelastic coefficient of 2×10⁻¹¹ m/N or less, a relationship of nx>ny=nz, and an in-plane retardation Re₁ of 200 to 300 nm. The second optical compensation layer contains a resin having an absolute value of a photoelastic coefficient of 2×10⁻¹¹ m²/N or less, a relationship of nx>ny=nz, and an in-plane retardation. Re₂ of 90 to 160 nm. The third optical compensation layer has a relationship of nx=ny>nz, an in-plane retardation Re₃ of 0 to 20 mm, and a thickness direction retardation Rth₃ of 30 to 300 nm. An angle formed by an absorption axis of the polarizer and a slow axis of the first optical compensation layer is 10 to 30°, and an angle formed by the absorption axis of the polarizer and a slow axis of the second optical compensation layer is 70 to 90°.

In another embodiment of the invention, the pressure-sensitive adhesive layer is provided between the polarizer and the first optical compensation layer.

In still another embodiment of the invention, the third optical compensation layer has a thickness of 1 to 50 μm.

In still another embodiment of the invention, the third optical compensation layer is formed of a cholesteric alignment fixed layer having a selective reflection wavelength region of 350 nm or less.

In still another embodiment of the invention, the third optical compensation layer includes a layer formed of a film having a relationship of nx=ny>nz and containing a resin having an absolute value of a photoelastic coefficient of 2×10⁻¹¹ m²/N or less, and a cholesteric alignment fixed layer having a selective reflection wavelength region of 350 nm or less.

In still another embodiment of the invention, the pressure-sensitive adhesive layer is formed of an acrylic pressure-sensitive adhesive.

In still another embodiment of the invention, the acrylic pressure-sensitive adhesive contains a (meth) acrylic polymer (A) obtained by copolymerizing 0.01 to 5 parts by weight of a hydroxyl group-containing (meth)acrylic monomer (a2) with respect to 100 parts by weight of alkyl(meth)acrylate (a1), a peroxide (B), and an isocyanate-based compound (C). The peroxide (B) is blended in an amount of 0.02 to 2 parts by weight with respect to 100 parts by weight of the (meth) acrylic polymer (A). The isocyanate-based compound (C) is blended in an amount of 0.001 to 2 parts by weight with respect to 100 parts by weight of the (meth)acrylic polymer (A).

According to another aspect of the invention, a liquid crystal panel is provided. The liquid crystal panel includes the polarizing plate with an optical compensation layer and a liquid crystal cell.

In one embodiment of the invention, the liquid crystal cell is a reflection-type or a semi-transmission-type liquid crystal cell of a VA mode.

According to still another aspect of the invention, a liquid crystal display apparatus is provided. The liquid crystal display apparatus includes the liquid crystal panel.

According to still another aspect of the invention, a image display apparatus is provided. The image display apparatus includes the polarizing plate with an optical compensation layer.

### EFFECTS OF THE INVENTION

As described above, according to the present invention, a pressure-sensitive adhesive layer with a dynamic storage shear modulus (G′) at 100° C. of 1.0×10⁴ to 6.0×10⁴ Pa is provided between a polarizer and an optical compensation layer, whereby a stress caused by a thermal expansion difference between the polarizer and the optical compensation layer under a high-temperature environment can be alleviated in the pressure-sensitive adhesive layer. Consequently, the degradation in optical properties caused by the thermal expansion difference between the polarizer and the optical compensation layer during the use under a high-temperature environment can be suppressed.

Further, according to the present invention, by providing a first optical compensation layer, a second optical compensation layer, and a third optical compensation layer in the stated order, and setting an angle formed by an absorption axis of a polarizer and each slow axis of the first optical compensation layer (λ/2 plate), the second optical compensation layer (λ/4 plate), and the third optical compensation layer (negative C plate) in a predetermined range, the problem of light leakage in a black display can be solved remarkably, particularly in a reflection-type and semi-transmission-type liquid crystal display apparatus of a VA mode. Further, by constituting a third optical compensation layer (negative C plate) with a cholesteric alignment fixed layer using a liquid crystal material and a chiral agent, the thickness can be remarkably reduced compared with that of a conventional negative C plate. Consequently, the present invention can largely contribute to the reduction in thickness of an image display apparatus. Further, by reducing the thickness of the third optical compensation layer (negative C plate), heat unevenness can be prevented remarkably.

### BRIEF DESCRIPTION OF THE DRAWINGS

FIG. 1 is a schematic cross-sectional view of a polarizing plate with an optical compensation layer according to a preferred embodiment of the present invention.

FIG. 2 is an exploded perspective view of a polarizing plate with an optical compensation layer according to a preferred embodiment of the present invention.

FIG. 3 is a schematic cross-sectional view of a liquid crystal panel used in a liquid crystal display apparatus according to a preferred embodiment of the present invention.

### REFERENCE NUMERALS

10 polarizing plate with an optical compensation layer
11 polarizer
12 first optical compensation layer
13 second optical compensation layer
14 third optical compensation layer
15 pressure-sensitive adhesive layer
20 liquid crystal cell
100 liquid crystal panel

### DETAILED DESCRIPTION OF PREFERRED EMBODIMENTS

### Definitions of Terms and Symbols

Definitions of terms and symbols in the specification of the present invention are described below.

(1) The symbol “nx” refers to a refractive index in a direction providing a maximum in-plane refractive index (that is, slow axis direction), the symbol “ny” refers to a refractive index in a direction perpendicular to the slow axis in the plane (that is, fast axis direction), and the symbol “nz” refers to a refractive index in a thickness direction. Further, the expression “nx=ny”, for example, not only refers to a case where nx and ny are exactly equal to each other, but also includes a case where nx and ny are substantially equal to each other. In the specification of the present invention, the phrase “substantially equal” includes a case where nx and ny differ within a range providing no effects on overall polarization properties of a polarizing plate with an optical compensation layer in practical use.

(2) The term “in-plane retardation Re” refers to an in-plane retardation value of a film (layer) measured at 23° C. by using light of a wavelength of 590 nm. Re can be determined from an equation: Re=(nx−ny)×d, where nx and ny represent refractive indices of a film (layer) at a wavelength of 590 nm in a slow axis direction and a fast axis direction, respectively, and d (nm) represents a thickness of the film (layer).

(3) The term “thickness direction retardation Rth” refers to a thickness direction retardation value measured at 23° C. by using light of a wavelength of 590 nm. Rth can be determined from an equation: Rth=(nx−nz)×d, where nx and nz represent refractive indices of a film (layer) at a wavelength of 590 nm in a slow axis direction and a thickness direction, respectively, and d (nm) represents a thickness of the film (layer).

(4) The subscripts “1”, “2”, and “3” attached to terms or symbols described in the specification of the present invention represents a first optical compensation layer, a second optical compensation layer, and a third optical compensation layer, respectively.

(5) The term “λ/2 plate” refers to a plate having a function of converting linearly polarized light having a specific vibration direction into linearly polarized light having a vibration direction perpendicular thereto, or converting right-handed circularly polarized light into left-handed circularly polarized light (or converting left-handed circularly polarized light into right-handed circularly polarized light). The λ/2 plate has an in-plane retardation value of a film (layer) of about ½ of a predetermined light wavelength (generally, in a visible light region).

(6) The term “λ/4 plate” refers to a plate having a function of converting linearly polarized light of a specific wavelength into circularly polarized light (or converting circularly polarized light into linearly polarized light). The λ/4 plate has an in-plane retardation value of a film (layer) of about ¼ of a predetermined light wavelength (generally, in a visible light region).

(7) The term “cholesteric alignment fixed layer” refers to a layer in which: molecules forming the layer form a helical structure; a helical axis of the helical structure is aligned substantially perpendicular to a plane direction; and an alignment state is fixed. Thus, the term “cholesteric alignment fixed layer” not only refers to the case where liquid crystal compound exhibits a cholesteric liquid crystal phase, but also includes the case where a non-liquid crystal compound has a pseudo structure of a cholesteric liquid crystal phase. For example, the “cholesteric alignment fixed layer” may be formed by: providing torsion to a liquid crystal material exhibiting a liquid crystal phase with a chiral agent for alignment into a cholesteric structure (helical structure); subjecting the liquid crystal material to polymerization treatment or crosslinking treatment for fixing the alignment (cholesteric structure) of the liquid crystal material.

(8) The phrase “selective reflection wavelength region of 350 nm or less” indicates that a center wavelength λ of a selective reflection wavelength region is 350 nm or less. For example, in the case where the cholesteric alignment fixed layer is formed by using a liquid crystal monomer, the center wavelength λ of the selective reflection wavelength region may be represented by the following equation.

λ=n×P

In the equation, n represents an average refractive index of the liquid crystal monomer, and P represents a helical pitch (nm) of the cholesteric alignment fixed layer. The average refractive index n is represented by (nₒ+nₑ)/2, and is generally within a range of 1.45 to 1.65. nₒ represents an ordinary refractive index of the liquid crystal monomer, and nₑ represents an extraordinary refractive index of the liquid crystal monomer.

(9) The term “chiral agent” refers to a compound having a function of aligning the liquid crystal material (nematic liquid crystals, for example) into a cholesteric structure.

(10) The term “torsional force” refers to ability of the chiral agent to provide torsion to the liquid crystal material and to align the liquid crystal material into a cholesteric structure (helical structure). In general, the torsional force may be represented by the following equation.

Torsional force=1/(P×W)

As described above, P represents a helical pitch (nm) of the cholesteric alignment fixed layer. W represents a weight ratio of the chiral agent. The weight ratio W of the chiral agent may be represented by W=[X/(X+Y)]×100. X represents a weight of the chiral agent, and Y represents a weight of the liquid crystal material.

A. Polarizing Plate with an Optical Compensation Layer

A-1. Entire Configuration of a Polarizing Plate with an Optical Compensation Layer

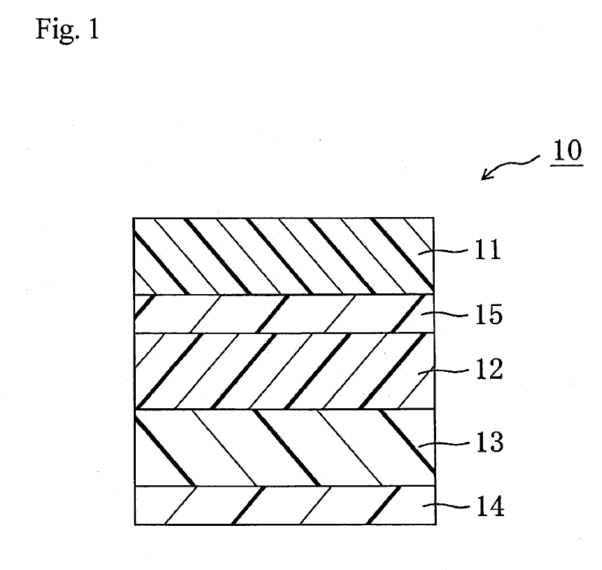

FIG. 1 is a schematic cross-sectional view of a polarizing plate with an optical compensation layer according to a preferred embodiment of the present invention. As shown in FIG. 1, a polarizing plate with an optical compensation layer 10 includes a polarizer 11, a pressure-sensitive adhesive layer 15, and at least one optical compensation layer in the stated order. At least one optical compensation layer according to the this embodiment includes a first optical compensation layer 12, a second optical compensation layer 13, and a third optical compensation layer 14 in the stated order. The respective layers of the polarizing plate with an optical compensation layer are laminated via any suitable pressure-sensitive adhesive layer or adhesive layer (not shown) in addition to the pressure-sensitive adhesive layer 15. Practically, any suitable protective film (not shown) is laminated on a side of the polarizer 11 on which an optical compensation layer is not formed. Further, if required, a protective film is provided between the polarizer 11 and the first optical compensation layer 12. The pressure-sensitive adhesive layer 15 is preferably provided between the polarizer 11 and the first optical compensation layer 12, as shown in the figure. Owing to such a configuration, the degradation in optical properties can be suppressed effectively.

The first optical compensation layer 12 preferably contains a resin with an absolute value of a photoelastic coefficient of 2×10⁻¹¹ m²/N or less, has a relationship of nx>ny=nz, and has an in-plane retardation Re₁ of 200 to 300 nm. The second optical compensation layer 13 preferably contains a resin with an absolute value of a photoelastic coefficient of 2×10⁻¹¹ cm²/N or less, has a relationship of nx>ny=nz, and has an in-plane retardation Re₂ of 90 to 160 nm. The third optical compensation layer 14 preferably has a relationship of nx=ny>nz, an in-plane retardation Re₃ of 0 to 20 nm and a thickness direction retardation Rth₃ of 30 to 300 nm. The detail of the first optical compensation layer, the second optical compensation layer, and the third optical compensation layer will be described later in items A-2, A-3, and A-4, respectively.

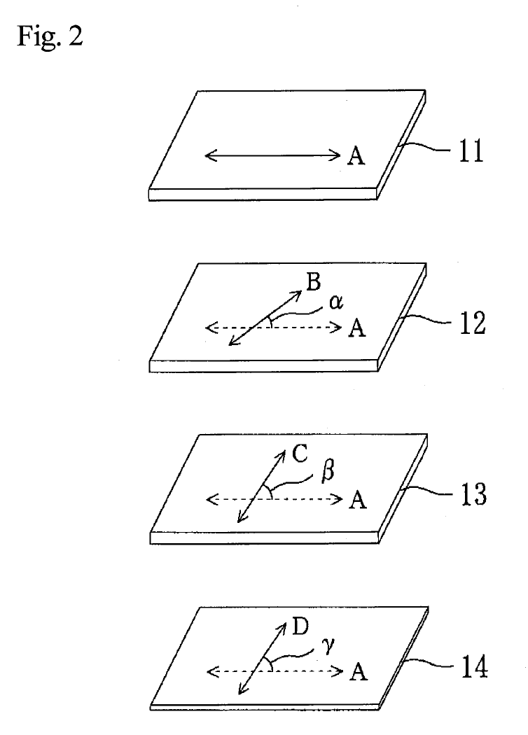

FIG. 2 is an exploded perspective view illustrating an optical axis of each layer constituting the polarizing plate with an optical compensation layer of FIG. 1 (pressure-sensitive adhesive layer 15 is not shown). In the present invention, as shown in FIG. 2, the first optical compensation layer 12 is laminated so that a slow axis B thereof forms a predetermined angle α with respect to an absorption axis A of the polarizer 11. The angle α is preferably 10 to 30°, more preferably 12 to 28°, and still more preferably 14 to 26° in a counterclockwise direction with respect to the absorption axis A of the polarizer 11. The second optical compensation layer 13 is laminated so that a slow axis C thereof forms a predetermined angle β with respect to the absorption axis A of the polarizer 11. The angle β is preferably 70 to 90°, more preferably 72 to 88°, and still more preferably 74 to 86° in a counterclockwise direction with respect to the absorption axis A of the polarizer 11. Further, in the case where the in-plane retardation Re₃ of the third optical compensation layer 14 is larger than 0, the third optical compensation layer 14 is laminated so that a slow axis D thereof forms a predetermined angle γ with respect to the absorption axis A of the polarizer 11. The angle γ is preferably 70 to 90°, more preferably 72 to 88°, and still more preferably 74 to 86° in a counterclockwise direction with respect to the absorption axis A of the polarizer 11. By laminating particular three optical compensation layers in such a particular positional relationship, light leakage in a black display in the liquid crystal display apparatus of a VA mode (in particular, a reflection-type or semi-transmission-type VA mode) can be prevented remarkably.

The entire thickness of the polarizing plate with an optical compensation layer of the present invention is preferably 80 to 270 μm, still more preferably 110 to 270 μm, and most preferably 140 to 270 μm. According to the present invention, by forming the third optical compensation layer (negative C plate described later) of a composition containing a liquid crystalline monomer and a chiral agent, the difference between nx and nz can be set to be much larger (nx>>nz). Consequently, the third optical compensation layer can be reduced in thickness largely. For example, the negative C plate by conventional biaxial stretching has a thickness of 60 μm or more, whereas the third optical compensation layer used in the present invention can be reduced in thickness to 2 μm. Consequently, compared with the conventional polarizing plate with an optical compensation layer having the same configuration (i.e., four-layer configuration), the polarizing plate with an optical compensation layer of the present invention can be reduced in total thickness greatly. Consequently, the polarizing plate with an optical compensation layer of the present invention can contribute to the reduction in thickness of an image display apparatus.

A-2. First Optical Compensation Layer

The first optical compensation layer 12 may serve as a λ/2 plate. The first optical compensation layer serves as a λ/2 plate, to thereby appropriately adjust retardation of wavelength dispersion properties (in particular, a wavelength range where the retardation departs from λ/4) of the second optical compensation layer serving as a λ/4 plate. Such a first optical compensation layer has an in-plane retardation Re₁ of 200 to 300 nm, preferably 220 to 280 nm, and more preferably 230 to 270 nm. The first optical compensation layer 12 has a refractive index profile of nx>ny=nz.

A thickness of the first optical compensation layer may be set such that it serves as a λ/2 plate most appropriately. That is, the thickness thereof is set to provide a desired in-plane retardation. To be specific, the thickness of the first optical compensation layer is preferably 37 to 53 μm, more preferably 40 to 50 μm, and most preferably 43 to 47 μm.

The first optical compensation layer 12 contains a resin having an absolute value of photoelastic coefficient of 2×10⁻¹¹ m²/N or less, preferably 2.0×10⁻¹³ to 1.0×10⁻¹¹ m²/N, and more preferably 1.0×10⁻¹² to 1.0×10⁻¹¹ m²/N. An absolute value of photoelastic coefficient within the above ranges hardly causes change in retardation due to shrinkage stress under heating. Thus, the first optical compensation layer may be formed by using a resin having such an absolute value of photoelastic coefficient, to thereby favorably prevent uneven display due to heat of an image display apparatus to be obtained.

Typical examples of the resin capable of satisfying such a photoelastic coefficient include a cyclic olefin-based resin and a cellulose-based resin. The cyclic olefin-based resin is particularly preferred. The cyclic olefin-based resin is a general term for a resin prepared through polymerization of a cyclic olefin as a monomer, and examples thereof include resins described in JP 1-240517 A, JP 3-14882 A, JP 3-122137 A, and the like. Specific examples thereof include: a ring opened (co)polymer of a cyclic olefin; an addition polymer of a cyclic olefin; a copolymer (typically, a random copolymer) of a cyclic olefin, and an α-olefin such as ethylene or propylene; their graft modified products each modified with an unsaturated carboxylic acid or its derivative; and hydrides thereof. A specific example of the cyclic olefin includes a norbornene-based monomer.

Examples of the norbornene-based monomer include: norbornene, its alkyl substitution and/or alkylidene substitution such as 5-methyl-2-norbornene, 5-dimethyl-2-norbornene, 5-ethyl-2-norbornene, 5-butyl-2-norbornene, 5-ethylidene-2-norbornene, and their products each substituted by a polar group such as halogen; dicyclopentadiene and 2,3-dihydrodicyclopentadiene; dimethano octahydronaphtalene, its alkyl substitution and/or alkylidene substitution, and their products each substituted by a polar group such as halogen, for example, 6-methyl-1,4:5,8-dimethano-1,4,4a,5,6,7,8,8a-octahydronaphtalene, 6-ethyl-1,4:5,8-dimethano-1,4,4a,5,6,7,8,8a-octahydronaphtalene, 6-ethylidene-1,4:5,8-dimethano-1,4,4a,5,6,7,8,8a-octahydronaphtalene, 6-chloro-1,4:5,8-dimethano-1,4,4a,5,6,7,8,8a-octahydronaphtalene, 6-cyano-1,4:5,8-dimethano-1,4,4a,5,6,7,8,8a-octahydronaphtalene, 6-pyridyl-1,4:5,8-dimethano-1,4,4a,5,6,7,8,8a-octahydronaphtalene, and 6-methoxycarbonyl-1,4:5,8-dimethano-1,4,4a,5,6,7,8,8a-octahydronaphtalene; and a trimer of cyclopentadiene and a tetramer of cyclopentadiene, for example, 4,9:5,8-dimethano-3a,4,4a,5,8,8a,9,9a-octahydro-1H-benzoindene and 4,11:5,10:6,9-trimethano-3a,4,4a,5,5a,6,9,9a,10,10a,11,11a-dodecahydro-1H-cyclopentaanthracene.

In the present invention, other ring-opening polymerizable cycloolefins can be combined without impairing the purpose of the present invention. Specific example of such cycloolefin includes a compound having one reactive double-bond, for example, cyclopentene, cyclooctene, and 5,6-dihydrodicyclopentadiene.

The cyclic olefin-based resin has a number average molecular weight (Mn) of preferably 25,000 to 200,000, more preferably 30,000 to 100,000, and most preferably 40,000 to 80,000 measured through a gel permeation chromatography (GPC) method by using a toluene solvent. A number average molecular weight within the above ranges can provide a resin having excellent mechanical strength, and favorable solubility, forming property, and casting operability.

In the case where the cyclic olefin-based resin is prepared through hydrogenation of a ring opened polymer of a norbornene-based monomer, a hydrogenation rate is preferably 90% or more, more preferably 95% or more, and most preferably 99% or more. A hydrogenation rate within the above ranges can provide excellent heat degradation resistance, light degradation resistance, and the like.

For the cyclic olefin-based resin, various products are commercially available. Specific examples of the resin include the trade names “ZEONEX” and “ZEONOR” each manufactured by ZEON CORPORATION, the trade name “Arton” manufactured by JSR Corporation, the trade name “TOPAS” manufactured by TICONA Corporation, and the trade name “APEL” manufactured by Mitsui Chemicals, Inc.

Any appropriate cellulose-based resin (typically an ester of cellulose and acid) may be employed as the cellulose-based resin. An ester of cellulose and fatty acid is preferred. Specific examples of such cellulose-based resin include cellulose triacetate (triacetylcellulose: TAC), cellulose diacetate, cellulose tripropionate, and cellulose dipropionate. Cellulose triacetate (triacetyl cellulose: TAC) is particularly preferred because it has low birefringence and high transmittance. In addition, many products of TAC are commercially available, and thus TAC has advantages of availability and cost.

Specific examples of commercially available products of TAC include the trade names “UV-50”, “UV-80”, “SH-50”, “SH-80”, “TD-80U”, “TD-TAC”, and “UZ-TAC” each manufactured by Fuji Photo Film CO., LTD., the trade name “KC series” manufactured by Konica Minolta Corporation, and the trade name “Triacetyl Cellulose 80 μm series” manufactured by Lonza Japan Corporation. Of those, “TD-80U” is preferred because of excellent transmittance and durability. In particular, “TD-80U” has excellent adaptability to a TFT-type liquid crystal display apparatus.

The first optical compensation layer 12 is preferably obtained by stretching a film formed of the cyclic olefin-based resin or the cellulose-based resin. Any appropriate forming method may be employed as a method of forming a film from the cyclic olefin-based resin or the cellulose-based resin. Specific examples thereof include a compression molding method, a transfer molding method, an injection molding method, an extrusion molding method, a blow molding method, a powder molding method, an FRP molding method, and a casting method. The extrusion molding method and the casting method are preferred because a film to be obtained may have enhanced smoothness and favorable optical uniformity. Forming conditions may appropriately be set in accordance with the composition or type of resin to be used, properties desired for the first optical compensation layer, and the like. Many film products of the cyclic olefin-based resin and the cellulose-based resin are commercially available, and the commercially available films may be subjected to the stretching treatment.

A stretch ratio of the film may vary depending on the in-plane retardation value and thickness desired for the first optical compensation layer, the type of resin to be used, the thickness of the film to be used, the stretching temperature, and the like. To be specific, the stretch ratio is preferably 1.75 to 2.05 times, more preferably 1.80 to 2.00 times, and most preferably 1.85 to 1.95 times. Stretching at such a stretch ratio may provide a first optical compensation layer having an in-plane retardation which may appropriately exhibit the effect of the present invention.

A stretching temperature of the film may vary depending on the in-plane retardation value and thickness desired for the first optical compensation layer, the type of resin to be used, the thickness of the film to be used, the stretch ratio, and the like. To be specific, the stretching temperature is preferably 130 to 150° C., more preferably 135 to 145° C., and most preferably 137 to 143° C. Stretching at such a stretching temperature may provide a first optical compensation layer having an in-plane retardation which may appropriately exhibit the effect of the present invention.

Referring to FIG. 1, the first optical compensation layer 12 is placed between the polarizer 11 and the second optical compensation layer 13. As a method of placing the first optical compensation layer, any suitable method can be adopted in accordance with the purpose. Typically, the first optical compensation layer 12 allows the polarizer 11 to bond thereto by providing a pressure-sensitive adhesive layer (pressure-sensitive adhesive layer 15 in the illustrated example) on one side, and allows the second optical compensation layer 13 to bond thereto by providing a pressure-sensitive adhesive layer (not shown) on the other side. By filling the gap between the respective layers with a pressure-sensitive adhesive layer, when they are incorporated in an image display apparatus, the relationship of optical axes of the respective layers can be prevented from being displaced, and each layer can be prevented from damaging each other by rubbing against each other. Further, the reflection at an interface between the layers is decreased, and a contrast can also be enhanced when used in an image display apparatus.

The thickness of each of the pressure-sensitive adhesive layers can be set appropriately in accordance with the intended use and the adhesive strength. Specifically, the thickness of each pressure-sensitive adhesive layer is preferably 1 μm to 100 μm, more preferably 5 μm to 50 μm, and most preferably 10 μm to 30 μm.

The pressure-sensitive adhesive layer 15 provided between the polarizer 11 and the optical compensation layer (first optical compensation layer 12 in the illustrated example) has a dynamic storage shear modulus (G′) at 100° C. of preferably 1.0×10⁴ to 6.0×10⁴ Pa, more preferably 1.0×10⁴ to 5.8×10⁴ Pa, and particularly preferably 1.0×10⁴ to 5.5×10⁴ Pa. When the dynamic storage shear modulus (G′) is in the above range, a stress caused by the thermal expansion difference between the polarizer and the optical compensation layer under a high-temperature atmosphere can be alleviated, and the displacement between the polarizer and the optical compensation layer can be prevented. Further, the polarizer tends to shrink in a stretching direction (absorption axis direction) under a high-temperature atmosphere. When the dynamic storage shear modulus (G′) is in the above range, the influence of the stress involved in the shrinking of the polarizer on the optical compensation layer is reduced, and the retardation of the optical compensation layer can be prevented from changing. Consequently, the degradation in optical properties caused by the thermal expansion difference between the polarizer and the optical compensation layer can be suppressed. Further, when the dynamic storage shear modulus (G′) is in the above range, the workability for forming the pressure-sensitive adhesive layer 15 is excellent. As described above, the pressure-sensitive adhesive layer 15 is preferably provided between the polarizer 11 and the first optical compensation layer 12 as shown. Such a configuration can suppress the degradation in optical properties effectively.

A typical example of the pressure-sensitive adhesive capable of satisfying the above dynamic storage shear modulus (G′) includes an acrylic pressure-sensitive adhesive. As specific examples, a pressure-sensitive adhesive 1 and a pressure-sensitive adhesive 2 will be described below.

(Pressure-Sensitive Adhesive 1)

Specific examples of the pressure-sensitive adhesive capable of satisfying the above dynamic storage shear modulus (G′) include an acrylic pressure-sensitive adhesive containing, as a base polymer, an acrylic polymer obtained by copolymerizing, as at least a copolymerization component, a monomer for copolymerization containing a functional group composed of 5-carboxypentyl acrylate, 4-hydroxybutyl (meth)acrylate, 6-hydroxyhexyl (meth)acrylate, 8-hydroxyoctyl (meth)acrylate, 10-hydroxydecyl (meth)acrylate, or 12-hydroxylauryl (meth)acrylate. Note that, in this specification, “(meth) acrylic acid” refers to acrylic acid and/or methacrylic acid.

The concentration of a functional group of the acrylic polymer is preferably 5×10⁻⁴ mol/g or less, more preferably 3×10⁻⁴ mol/g or less, and still more preferably 1×10⁻⁴ mol/g or less. When the concentration of a functional group is in the above range, appropriate adhesive strength is obtained to such a degree that the polarizer and the optical compensation layer are bonded to each other satisfactorily, and the polarizer and the optical compensation layer are not damaged during reworking.

The 90-degree peeling adhesive strength of the pressure-sensitive adhesive layer 15 formed of the acrylic pressure-sensitive adhesive with respect to the polarizer or the optical compensation layer is preferably 600 g/20 mm or less, more preferably 50 to 500 g/20 mm, and still more preferably 100 to 400 g/20 mm. Note that the 90-degree peeling adhesive strength is measured by the following method. A pressure-sensitive adhesive layer with a thickness of 50 μm is formed on the polarizer or the optical compensation layer using the acrylic pressure-sensitive adhesive, and cut to a width of 20 mm. Those layers are crimped onto a glass plate by allowing a rubber roller of 2 kg to reciprocate, and left standing in an autoclave at 50° and 5 atmospheric pressure for 30 minutes to be matured. After that, the strength required for peeing the layers at an angle of 90° with respect to the glass plate at 25° C. and 100 mm/min is measured.

(Pressure-Sensitive Adhesive 2)

Another specific example of the pressure-sensitive adhesive capable of satisfying the dynamic storage shear modulus (G′) as described above includes an acrylic pressure-sensitive adhesive containing a (meth)acrylic polymer (A), a peroxide (B), and an isocyanate-based compound (C). In the acrylic pressure-sensitive adhesive, the peroxide (B) is blended in an amount of 0.02 to 2 parts by weight with respect to 100 parts by weight of the (meth)acrylic polymer (A), and the isocyanate-based compound (C) is blended in an amount of 0.01 to 2 parts by weight with respect to 100 parts by weight of the (meth) acrylic polymer (A). Further, the (meth) acrylic polymer (A) which is a base polymer is obtained by copolymerizing 0.01 to 5 parts by weight of the hydroxyl group-containing (meth)acrylic monomer (a2) with respect to 100 parts by weight of alkyl(meth)acrylate (a1). Note that, in this specification, “(meth) acrylic” refers to acrylic and/or methacrylic. Further “(meth)acrylate” refers to acrylate and/or methacrylate.

The number of carbon atoms of an alkyl group in alkyl (meth)acrylate (a1) which forms a main skeleton of the (meth)acrylic polymer (A) is preferably about 1 to 18, and more preferably 1 to 9. Examples of alkyl (meth)acrylate (a1) include methyl(meth)acrylate, ethyl (meth)acrylate, propyl (meth)acrylate, n-butyl (meth)acrylate, iso-butyl (meth)acrylate, 2-ethylhexyl (meth)acrylate, n-octyl (meth)acrylate, iso-octyl (meth)acrylate, lauryl (meth)acrylate, isononyl (meth)acrylate, stearyl (meth)acrylate, and cyclohexyl (meth)acrylate. They may be used alone or in combination. When they are used in combination, an average number of carbon atoms of an alkyl group in the alkyl (meth)acrylate (a1) is preferably 3 to 9.

Examples of the hydroxyl group-containing (meth)acrylic monomer (a2) forming the (meth)acrylic polymer (A) include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethyl cyclohexyl)-methyl acrylate. They may be used alone or in combination.

It is preferred that the number of carbons of a hydroxyalkyl group of the hydroxyl group-containing (meth) acrylic monomer (a2) is 4 or more. This is because the reactivity with the isocyanate-based compound (C) described later is high. In this case, it is preferred that the number of carbons of an alkyl group of the alkyl(meth)acrylate (a1) is equal to or less than that of a hydroxyalkyl group of the hydroxyl group-containing (meth) acrylic monomer (a2). For example, in the case of using 4-hydroxybutyl (meth)acrylate as the hydroxyl group-containing (meth)acrylic monomer (a2), methyl(meth)acrylate, ethyl(meth)acrylate, propyl(meth)acrylate, or butyl(meth)acrylate is preferably used as the alkyl(meth)acrylate (a1).

The copolymerization amount of the hydroxyl group-containing (meth)acrylic monomer (a2) is preferably 0.01 to 5 parts by weight, more preferably 0.01 to 4 parts by weight, and still more preferably 0.03 to 3 parts by weight with respect to 100 parts by weight of alkyl(meth)acrylate (a1). When the copolymerization amount of the hydroxyl group-containing (meth)acrylic monomer (a2) is less than 0.01 parts by weight, the number of cross-linking points with an isocyanate cross-linking agent decreases, and the adhesiveness and durability with respect to the polarizer and the optical compensation layer may be degraded. On the other hand, in the case where the copolymerization amount of the hydroxyl group-containing (meth) acrylic monomer (a2) exceeds parts by weight, the number of cross-linking points increases too much, and the alleviation of a stress may be degraded.

The (meth) acrylic polymer (A) can also be obtained by copolymerizing not only the alkyl(meth)acrylate (a1) and the hydroxyl group-containing (meth) acrylic monomer (a2) but also other components. As other components, although not limited, benzyl(meth)acrylate, methoxyethyl(meth)acrylate, ethoxymethyl(meth)acrylate, phenoxyethyl(meth)acrylate, (meth) acrylamide, vinyl acetate, (meth) acrylonitrile, and the like are preferred. The copolymerization amount of the other components is preferably 100 parts by weight or less and more preferably 50 parts by weight or less with respect to 100 parts by weight of the alkyl(meth)acrylate (a1).

The weight average molecular weight of the (meth)acrylic polymer (A) is preferably about 500,000 to 2,500,000.

The (meth)acrylic polymer (A) can be produced by any suitable method. For example, a radical polymerization method such as a bulk polymerization method, a solution polymerization method, and a suspension polymerization method can be appropriately selected. In the radical polymerization method, any suitable radical polymerization initiator (for example, an azo-base, a peroxide-based) can be used. The reaction temperature is generally about 50 to 80° C., and the reaction time is generally 1 to 8 hours. Of the production methods, a solution polymerization method is preferred. Examples of a solvent used in the solution polymerization method generally include ethyl acetate and toluene. The solution concentration is generally about 20 to 80% by weight.

In the case of using a peroxide as the radial polymerization initiator, a peroxide remaining without being used for a polymerization reaction can also be used for a cross-linking reaction described later. Herein, in the case where the remaining amount of a peroxide is quantified and the ratio of a peroxide is less than a predetermined amount, a peroxide can be added so as to reach the predetermined amount, if required.

The peroxide (B) is not particularly limited, as long as it generates a radical by heating to achieve cross-linking of the (meth)acrylic polymer (A). In the case of considering productivity, the one-minute half-life temperature of the peroxide (B) is about 70 to 170° C., and more preferably 90 to 150° C. When the one-minute half-life temperature is too low, a cross-linking reaction occurs during storage before applying a pressure-sensitive adhesive, and the viscosity of an applying substance may increase to make applying difficult. On the other hand, when the one-minute half-life temperature is too high, the temperature during the cross-linking reaction may increase to cause another side effect, intended properties cannot be obtained due to insufficient decomposition, and a cross-linking reaction may proceed with the passage of time with the peroxide remaining.

The half-life of a peroxide is an index indicating the decomposition rate of a peroxide, and is a time when the decomposition amount of a peroxide becomes a half. The decomposition temperature for obtaining a half-life at a predetermined time and the half-life time at a predetermined temperature are as described in manufacturer catalogues, etc., and for example, in Organic peroxide catalogue 9th Ed. (May 2003) of NOF Corporation.

Examples of the peroxide (B) which may satisfy the half-life temperature include di(2-ethylhexyl)peroxy dicarbonate, di(4-t-butylcyclohexyl)peroxy dicarbonate, di-sec-butylperoxy dicarbonate, t-butylperoxy neodecanoate, t-hexylperoxy pivalate, t-butylperoxy pivalate, dilauroyl peroxide, di-n-octanoylperoxide, 1,1,3,3-tetramethylbutylperoxy isobutyrate, and dibenzoylperoxide. Of those, di(4-t-butylcylohexyl)peroxy dicarbonate, dilauroyl peroxide, and dibenzoyl peroxide are preferably used because of their excellent cross-linking reaction efficiencies.

The blending amount of the peroxide (B) is preferably 0.02 to 2 parts by weight, more preferably 0.05 to 1 parts by weight, and still more preferably 0.06 to 0.5 parts by weight with respect to 100 parts by weight of the (meth) acrylic polymer (A). When the use amount of the peroxide (B) is less than 0.02 parts by weight, a cross-linking reaction may become insufficient, with the result that durability may become insufficient. On the other hand, when the blending amount exceeds 2 parts by weight, an adhesiveness may be degraded due to excess cross-linking.

The isocyanate-based compound (C) contains an isocyanate compound. Examples of isocyanate compounds include: isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate, and hydrogenated diphenylmethane diisocyate; adduct-based isocyanate compounds obtained by adding those isocyanate monomers to a multivalent alcohol such as trimethylolpropane; isocyanurate compounds; burette type compounds; and urethane prepolymer type isocyanate obtained by addition reaction of any appropriate polyether polyol, polyester polyol, acryl polyol, polybutadiene polyol, polyisoprene polyol, or the like. Of those, an adduct-based isocyanate compound such as xylylene diisocyanate is preferably used. This is because the adhesiveness with respect to the polarizer and the optical compensation layer is satisfactory.

The blending amount of the isocyanate-based compound (C) is preferably 0.001 to 2 parts by weight, more preferably 0.01 to 1.5 parts by weight, and still more preferably 0.02 to 1 parts by weight with respect to 100 parts by weight of the (meth)acrylic polymer (A). When the use amount of the isocyanate-based compound (C) is less than 0.001 parts by weight, the adhesiveness with respect to the polarizer and the optical compensation layer, and durability may be degraded. On the other hand, when the blending amount of the isocyanate-based compound (C) exceeds 2 parts by weight, the workability may be degraded.

The acrylic pressure-sensitive adhesive (pressure-sensitive adhesive 1 and pressure-sensitive adhesive 2) can further contain various kinds of additives in a range not deviating from the object of the present invention. Examples of the additive include a filler formed of inorganic powder such as glass fibers, glass beads, and metal powder, a tackifier, a plasticizer, a pigment, a colorant, an antioxidant, a UV absorbing agent, and a silane coupling agent. Further, light diffusibility may be provided by blending fine particles.

Among the above additives, it is preferred to blend the silane coupling agent. This is because the decrease in durability, in particular, the peeling under a humidification environment can be suppressed. As the silane coupling agent, silicon compounds having an epoxy structure, such as 3-glycidoxypropyltrimethoxysilane, 3-glycidoxypropylmethyl-dimethoxysilane, and 2-(3,4-epoxycyclohexyl)ethyltrimethoxysilane; silicon compounds containing an amino group, such as 3-aminopropyltrimethoxysilane, N-(2-aminoethyl)3-aminopropyl-trimethoxysilane, N-(2-aminoethyl)3-aminopropylmethyl-dimethoxysilane; 3-chloropropyltrimethoxysilane; trimethoxysilane containing an acetoacetyl group; a silane coupling agent containing a (meth) acryl group, such as 3-acryloxypropyltrimethoxysilane and 3-methacryloxypropyltriethoxysilane; and a silane coupling agent containing an isocyanate group such as 3-isocyanatepropyltriethoxysilane. Of those, 3-glycidoxypropyltrimethoxysilane and a trimethoxysilane containing an acetoacetyl group are preferably used. This is because peeing can be suppressed effectively. The blending amount of the silane coupling agent is, for example, preferably 1 part by weight or less, more preferably 0.01 to 1 part by weight, and still more preferably 0.02 to 0.6 parts by weight with respect to 100 parts by weight of the (meth) acrylic polymer (A). When the use amount of the silane coupling agent increases, the adhesive strength to the polarizer and the optical compensation layer increases too much, which may influence reworkability.

The acrylic pressure-sensitive adhesive (pressure-sensitive adhesive 1 and pressure-sensitive adhesive 2) are preferably used as a solvent-type pressure-sensitive adhesive.

(Anchor Coat Layer)

An anchor coat layer may be provided between the polarizer 11 and the pressure-sensitive adhesive layer 15, and/or between the pressure-sensitive adhesive layer 15 and the optical compensation layer (for example, the first optical compensation layer 12). The material for forming the anchor coat layer is not particularly limited. However, the material that exhibits satisfactory adhesiveness with respect to the pressure-sensitive adhesive layer 15, the polarizer, and the optical compensation layer, and forms a coating film excellent in a cohesive force is preferred. Examples of the material that exhibits such properties include various kinds of polymer compositions, a sol of a metal oxide, and silica sol. Of those, the polymer compositions are preferably used.

Examples of the polymer include a polyurethane-based resin, a polyester-based resin, and a composition containing a polymer having an amino group in a molecule. The polymer composition may be any of a solvent soluble type, a water dispersion type, and a water soluble type. Examples of the water soluble type include a water-soluble polyurethane composition, a water-soluble polyester composition, and a water-soluble polyamide composition. Examples of the water dispersion type include an ethylene-vinyl acetate-based emulsion and a (meth)acrylic emulsion. Further, as the water dispersion type, there can be used: an emulsion obtained by emulsifying various kinds of resins such as polyurethane, polyester, and polyamide, using an emulsifier; a self-emulsified emulsion obtained by introducing an anionic group, a cationic group, or a nonionic group that is a water dispersion hydroxyl group into the resin; and the like. An ion polymer complex can also be used.

The polymer in the composition preferably has a functional group having a reactivity with respect to the isocyanate-based compound (C) in the pressure-sensitive adhesive layer 15. As such a polymer, a polymer containing an amino group in a molecule is preferably used, and a polymer having a primary amino group at a terminal is particularly preferably used. Examples of the polymer containing an amino group in a molecule include polymers of monomers containing an amino group, such as polyethyleneimine, polyallylamine, polyvinylamine, polyvinylpyridine, polyvinylpyrrolidine, and dimethylaminoethyl acrylate. Of those, polyethyleneimine is preferably used.

The polyethyleneimine is not particularly limited, and any suitable polyethyleneimine can be used. The weight average molecular weight of polyethyleneimine is not particularly limited, but generally about 100 to 1,000,000. Examples of the commercially available products of polyethyleneimine include Epomine SP series (SP-003, SP006, SP012, SP018, SP103, SP110, SP200, etc.), and Epomine P-1000, manufactured by Nippon Shokubai Co., Ltd. Of those, Epomine P-1000 is preferably used.

The polyethyleneimine may have a polyethylene structure, and examples of the polyethyleneimine include an ethyleneimine adduct and/or a polyethyleneimine adduct to a polyacrylate. Such a polyacrylate is obtained by emulsion-polymerizing alkyl(meth)acrylate and an appropriate copolymerization monomer in accordance with an ordinary method. As the alkyl(meth)acrylate, those similar to the alkyl(meth)acrylate (a1) constituting a base polymer of the pressure-sensitive adhesive 2 can be adopted. As the copolymerization monomer, there is a monomer having a functional group that reacts with ethyleneimine, such as a carboxyl group. As the copolymerization monomer, a styrene-based monomer is also preferably used. The use ratio of the copolymerization monomer is appropriately adjusted depending upon the ratio of ethyleneimine to be reacted. Further, by allowing polyethyleneimine separately synthesized to react with a carboxyl group and the like in an acrylate, an adduct grafted with polyethyleneimine can also be obtained. Particularly preferred examples of commercially available products include Polyment NK-380, 350 manufactured by Nippon Shokubai Co., Ltd.

As the polyethyleneimine, an ethyleneimine adduct and/or a polyethyleneimine adduct, etc. of an acrylic polymer emulsion can also be used. Examples of commercially available products include Polyment SK-1000 manufactured by Nippon Shokubai Co., Ltd.

The polyallylamine is not particularly limited, and examples thereof include: allylamine-based compounds such as a diallylamine hydrochloride-sulfur dioxide copolymer, a diallylmethylamine hydrochloride copolymer, a polyallylamine hydrochloride, and polyallylamine; a condensate of polyalkylenepolyamine such as diethylenetriamine and dicarboxylic acid; an adduct of epihalohydrin; and polyvinylamine. It is preferred that the polyallylamine be soluble in water and/or alcohol. The weight average molecular weight of the polyallylamine is not particularly limited, but preferably about 10,000 to 100,000.

As the pressure-sensitive adhesive forming a pressure-sensitive adhesive layer provided between the first optical compensation layer 12 and the second optical compensation layer 13, any suitable pressure-sensitive adhesive can be adopted. Specific examples thereof include a solvent-type pressure-sensitive adhesive, a non-aqueous emulsion type pressure-sensitive adhesive, an aqueous pressure-sensitive adhesive, and a hot-melt pressure-sensitive adhesive. A solvent-type pressure-sensitive adhesive using an acrylic polymer as a base polymer is preferably used. This is because the solvent-type pressure-sensitive adhesive exhibits appropriate pressure-sensitive adhesive properties (wettability, cohesion, and adhesion) with respect to the polarizer, the first optical compensation layer, and the second optical compensation layer and is excellent in optical transparency, weather resistance, and heat resistance. A pressure-sensitive adhesive forming the pressure-sensitive adhesive layer 15 can also be adopted. As described above, an anchor coat layer may be provided between the first optical compensation layer 12 and the pressure-sensitive adhesive layer, and/or between the pressure-sensitive adhesive layer and the second optical compensation layer 13.

A-3. Second Optical Compensation Layer

The second optical compensation layer 13 may serve as a λ/4 plate. According to the present invention, the wavelength dispersion characteristics of the second optical compensation layer serving as a λ/4 plate are corrected by optical characteristics of the first optical compensation layer serving as a λ/2 plate, to thereby exhibit circularly polarizing function over a wide wavelength range. An in-plane retardation Re₂ of the second optical compensation layer is preferably 90 to 160 nm, more preferably 100 to 150 nm, and particularly preferably 110 to 140 nm. Further, the second optical compensation layer 13 may have a refractive index profile of nx>ny=nz.

A thickness of the second optical compensation layer may be set so that it serves as a λ/4 plate most appropriately. That is, the thickness thereof is set to provide a desired in-plane retardation. To be specific, the thickness is preferably 42 to 58 μm, more preferably 45 to 55 μm, and most preferably 48 to 52 μm.

The second optical compensation layer 13 contains a resin having an absolute value of a photoelastic coefficient of preferably 2×10⁻¹¹ m²/N or less, more preferably 2.0×10⁻¹³ to 1.0×10⁻¹¹, and still more preferably 1.0×10⁻¹² to 1.0×10⁻¹¹. When the absolute value of the photoelastic coefficient is in the above range, a retardation is unlikely to change when a shrinkage stress during heating occurs. Thus, by forming a second optical compensation layer using a resin having the above absolute value of a photoelastic coefficient, heat unevenness of an image display apparatus to be obtained can be satisfactorily prevented in cooperation with the effect of the first optical compensation layer.

Typical examples of a resin capable of satisfying the above photoelastic coefficient include a cyclic olefin-based resin and a cellulose-based resin. The details of the cyclic olefin-based resin and cellulose-based resin are as described in the item A-2.

An in-plane retardation Re₂ of the second optical compensation layer 13 can be controlled by changing the stretching ratio and the stretching temperature of the cyclic olefin-based resin film and cellulose-based resin film described in the item A-2. The stretching ratio can change depending upon the in-plane retardation and thickness desired for the second optical compensation layer, the kind of a resin to be used, the thickness of a film to be used, a stretching temperature, and the like. Specifically, the stretching ratio is preferably 1.17 to 1.47 times, more preferably 1.22 to 1.42 times, and most preferably 1.27 to 1.37 times. By stretching a film with such a ratio, a second optical compensation layer having an in-plane retardation capable of appropriately exhibiting the effect of the present invention can be obtained.

The stretching temperature can change depending upon the in-plane retardation and thickness desired for the second optical compensation layer, the kind of a resin to be used, the thickness of a film to be used, a stretching ratio, and the like. Specifically, the stretching temperature is preferably 130 to 150° C., more preferably 135 to 145° C., and most preferably 137 to 143° C. By stretching a film at such a temperature, a second optical compensation layer having an in-plane retardation capable of appropriately exhibiting the effect of the present invention can be obtained.

Referring to FIG. 1, the second optical compensation layer 13 is placed between the first optical compensation layer 12 and the third optical compensation layer 14. As a method of placing the second optical compensation layer, any suitable method can be adopted depending upon the purpose. Typically, a pressure-sensitive adhesive layer (not shown) is provided on the first optical compensation layer 12 side of the second optical compensation layer 13, and the first optical compensation layer 12 is attached thereto. An adhesive layer (not shown) is provided on the third optical compensation layer 14 side of the second optical compensation layer 13, and the third optical compensation layer 14 is attached thereto. In the case where the third optical compensation layer 14 has a laminate structure (for example, a cholesteric alignment fixed layer/plastic film layer), the second optical compensation layer 13 and the plastic film layer are attached to each other via a pressure-sensitive adhesive layer, and the cholesteric alignment solidified layer and the plastic film layer are attached to each other via an adhesive layer. The detail of the pressure-sensitive adhesive layer is as described in the item A-2.

A typical example of the adhesive forming the adhesive layer includes a curable adhesive. Typical examples of the curable adhesive include a light-curable adhesive such as a UV-curable adhesive, a moisture-curable adhesive, and a thermosetting adhesive. Specific examples of the thermosetting adhesive include thermosetting resin-based adhesives such as an epoxy resin, an isocyanate resin, and a polyimide resin. A specific example of the moisture-curable adhesive includes an isocyanate resin-based moisture-curable adhesive. The moisture-curable adhesive (in particular, an isocyanate resin-based moisture-curable adhesive) is preferred. The moisture-curable adhesive is cured by reacting with moisture in air, water adsorbing to the surface of an adherent, activated hydrogen group such as a hydroxyl group and a carboxyl group, and the like. Therefore, the moisture-curable adhesive can be cured naturally by being left standing after being applied, and hence, the moisture-curable adhesive is excellent in operability. Further, it is not necessary to heat the moisture-curable adhesive for curing, so the third optical compensation layer is not heated during lamination (bonding). As a result, there is no possibility of heat shrink, even in the case where the third optical compensation layer is very thin, and cracks and the like during lamination can be prevented remarkably. In addition, the curable adhesive hardly shrinks even if heated after curing. Thus, even in the case where the third optical compensation layer is very thin, and a polarizing plate to be obtained is used under a high-temperature condition, cracks and the like of the third optical compensation layer can be remarkably prevented. Note that the isocyanate resin-based adhesive is a generic name of a polyisocyanate-based adhesive and a polyurethane resin adhesive.

As the curable adhesive, for example, a commercially available adhesive may be used, or various kinds of the curable resins may be dissolved or dispersed in a solvent to prepare a curable resin adhesive solution (or dispersion). In the case of preparing a solution (or dispersion), as the content of the curable resin in the solution, the weight of a solid content is preferably 10 to 80% by weight, more preferably 20 to 65% by weight, particularly preferably 25 to 65% by weight, and most preferably 30 to 50% by weight. As a solvent to be used, any suitable solvent can be adopted depending upon the kind of a curable resin. Specific examples include ethyl acetate, methyl ethyl ketone, methyl isobutyl ketone, toluene, and xylene. They may be used alone or in combination.

The applying amount of an adhesive with respect to the second optical compensation layer can be set appropriately depending upon the purpose. For example, the applying amount is preferably 0.3 to 3 ml, more preferably 0.5 to 2 ml, and most preferably 1 to 2 ml per area (cm²) of the second optical compensation layer. After the applying, if required, a solvent contained in an adhesive is vaporized by natural drying or heat drying. The thickness of an adhesive layer thus obtained is preferably 0.1 μm to 20 μm, more preferably 0.5 μm to 15 μm, and most preferably 1 μm to 10 μm. Further, the microhardness of an adhesive layer is preferably 0.1 to 0.5 GPa, more preferably 0.2 to 0.5 GPa, and most preferably 0.3 to 0.4 GPa. Regarding the microhardness, the correlation with a Vickers hardness is known, so the microhardness can also be converted to a Vickers hardness. The microhardness can be calculated from the push-in depth and push-in load using, for example, a thin film hardness meter (for example, MH4000 (trade name), MHA-400 (trade name)) manufactured by NEC Corporation.

A-4. Third Optical Compensation Layer

### A-4-1. Entire Configuration of a Third Optical Compensation Layer

The third optical compensation layer 14 has a relationship of nx=ny>nz, and can function as a so-called negative C plate. The third optical compensation layer has such a refractive index profile, therefore the birefringence of a liquid crystal layer of a VA-mode liquid crystal cell can be compensated satisfactorily. Consequently, a liquid crystal display apparatus with viewing angle properties enhanced remarkably can be obtained. As described above, in the present specification, “nx=ny” includes not only the case where nx and ny are strictly equal to each other, but also the case where nx and ny are substantially equal to each other. Therefore, the third optical compensation layer can have an in-plane retardation, and can have a slow axis. The in-plane retardation Re₃ practically allowable for the negative C plate is preferably 0 to 20 nm, more preferably 0 to 10 nm, and still more preferably 0 to 5 nm.

The thickness direction retardation Rth₃ of the third optical compensation layer 14 is preferably 30 to 300 nm, more preferably 60 to 180 nm, still more preferably 80 to 150 nm, and most preferably 100 to 120 nm. The thickness of the third optical compensation layer in which such a thickness direction retardation can be obtained can be changed depending upon a material to be used and the like. For example, the thickness of the third optical compensation layer is preferably 1 to 50 μm, more preferably 1 to 20 μm, and most preferably 1 to 15 μm. In the case where the third optical compensation layer is formed of a cholesteric alignment fixed layer (described later) alone, the thickness thereof is preferably 1 to 10 μm, more preferably 1 to 8 μm, and most preferably 1 to 5 μm. Such a thickness is smaller than the thickness of a negative C plate (for example, 60 μm or more) by biaxial stretching, which can contribute greatly to the reduction in thickness of an image display apparatus. Further, by forming the third optical compensation layer very thinly, heat unevenness can be prevented remarkably. Further, such a very thin optical compensation layer is preferred from the viewpoint of the prevention of the disturbance of cholesteric alignment and decrease in transmittance, selective reflectivity, coloring prevention, productivity, and the like. The third optical compensation layer (negative C plate) of the present invention is formed of any suitable material as long as the above-mentioned thickness and optical properties are obtained. Preferably, the very thin negative C plate as described above is realized by forming cholesteric alignment using a liquid crystal material and fixing the cholesteric alignment, i.e., by using a cholesteric alignment fixed layer (the details of a material for forming cholesteric alignment and a method for fixing cholesteric alignment will be described later).

Preferably, the third optical compensation layer 14 is formed of a cholesteric alignment fixed layer having a selective reflection wavelength region of 350 nm or less. An upper limit of the selective reflection wavelength region is more preferably 320 nm or less, and most preferably 300 nm or less. Meanwhile, a lower limit of the selective reflection wavelength region is preferably 100 nm or more, and more preferably 150 nm or more. In the case where the selective reflection wavelength region is more than 350 nm, the selective reflection wavelength region covers a visible light region and thus may cause a problem such as coloring or decoloring. In the case where the selective reflection wavelength region is less than 100 nm, amount of a chiral agent (described below) to be used increases excessively and thus a temperature during formation of an optical compensation layer must be controlled very accurately. As a result, a polarizing plate may hardly be produced.

A helical pitch in the cholesteric alignment fixed layer is preferably 0.01 to 0.25 μm, more preferably 0.03 to 0.20 μm, and most preferably 0.05 to 0.15 μm. A helical pitch of 0.01 μm or more provides sufficient alignment property, for example. A helical pitch of 0.25 μm or less allows sufficient suppression of rotary polarization in a shorter wavelength side of visible light, to thereby sufficiently prevent light leak and the like. The helical pitch may be controlled by adjusting the type (torsional force) and amount of the chiral agent as described below. The helical pitch may be adjusted, to thereby control the selective reflection wavelength region within a desired range.

Alternatively, the third optical compensation layer 14 may have a laminate structure of the cholesteric alignment fixed layer and a layer (also referred to as a plastic film layer in the specification of the present invention) having a relationship of nx=ny>nz and containing a resin having an absolute value of photoelastic coefficient of 2×10⁻¹¹ m²/N or less. Typical examples of a material capable of forming the plastic film layer (resin capable of satisfying such a photoelastic coefficient) include a cyclic olefin-based resin and a cellulose-based resin. Details of the cyclic olefin-based resin and the cellulose-based resin are as described in the above section A-2. A cellulose-based resin film (typically, a TAC film) is a film having a relationship of nx=ny>nz.

### A-4-2. Liquid Crystal Composition Forming Third Optical Compensation Layer (Cholesteric Alignment Fixed Layer): Liquid Crystal Material

The third optical compensation layer (cholesteric alignment fixed layer) may be formed of a liquid crystal composition. Any appropriate liquid crystal material may be used as a liquid crystal material to be included in the composition. The liquid crystal material (nematic liquid crystals) preferably has a liquid crystal phase of a nematic phase. Examples of such a liquid crystal material that may be used include a liquid crystal polymer and a liquid crystal monomer. The liquid crystal material may exhibit liquid crystallinity through a lyotropic or thermotropic mechanism. Further, liquid crystals are preferably aligned in homogeneous alignment. A content of the liquid crystal material in the liquid crystal composition is preferably 75 to 95 wt %, and more preferably 80 to 90 wt %. In the case where the content of the liquid crystal material is less than 75 wt %, the composition may not sufficiently exhibit a liquid crystal state and thus the cholesteric alignment may not be formed sufficiently. In the case where the content of the liquid crystal material is more than 95 wt %, a content of a chiral agent may be reduced to prevent sufficient torsion to be provided and thus the cholesteric alignment may not be formed sufficiently.

The liquid crystal material is preferably a liquid crystal monomer (polymerizable monomer or crosslinking monomer, for example) because an alignment state of the liquid crystal monomer can be fixed by polymerizing or crosslinking the liquid crystal monomer as described below. The alignment state may be fixed by aligning the liquid crystal monomer and then, for example, polymerizing or crosslinking the liquid crystal monomers with each other. As a result, a polymer is formed through polymerization and a three-dimensional network structure is formed through crosslinking. The polymer and the three-dimensional network structure are non-liquid crystalline. Thus, the thus-formed third optical compensation layer does not transfer into, for example, a liquid crystal phase, glass phase, or crystal phase due to temperature change unique to a liquid crystal compound. As a result, the third optical compensation layer realizes an optical compensation layer having very excellent stability and not affected by the temperature change.

Any suitable liquid crystal monomers may be employed as the liquid crystal monomer. For example, there are used polymerizable mesogenic compounds and the like described in JP 2002-533742 A (WO 00/37585), EP 358208 (U.S. Pat. No. 5,211,877), EP 66137 (U.S. Pat. No. 4,388,453), WO 93/22397, EP 0261712, DE 19504224, DE 4408171, GB 2280445, and the like. Specific examples of the polymerizable mesogenic compounds include: LC242 (trade name) available from BASF Aktiengesellschaft; E7 (trade name) available from Merck & Co., Inc.; and LC-Silicone-CC3767 (trade name) available from Wacker-Chemie GmbH.

For example, a nematic liquid crystal monomer is preferred as the liquid crystal monomer, and a specific example thereof includes a monomer represented by the below-indicated formula (1). The liquid crystal monomer may be used alone or in combination of two or more thereof.

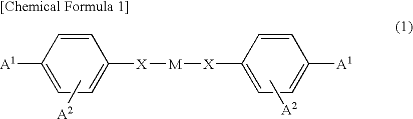

In the above formula (1), A¹ and A² each represent a polymerizable group, and may be the same or different from each other. One of A¹ and A² may represent hydrogen. Each X independently represents a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR—. R represents H or an alkyl group having 1 to 4 carbon atoms. M represents a mesogen group.

In the above formula (1), Xs may be the same or different from each other, but are preferably the same.

Of monomers represented by the above formula (1), each A² is preferably arranged in an ortho position with respect to A¹.

A¹ and A² are preferably each independently represented by the below-indicated formula (2), and A¹ and A² preferably represent the same group.

Z-X-(Sp)ₙ (2)

In the above formula (2), Z represents a crosslinkable group, and X is the same as that defined in the above formula (1). Sp represents a spacer consisting of a substituted or unsubstituted linear or branched alkyl group having 1 to 30 carbon atoms. n represents 0 or 1. A carbon chain in Sp may be interrupted by oxygen in an ether functional group, sulfur in a thioether functional group, a non-adjacent imino group, an alkylimino group having 1 to 4 carbon atoms, or the like.

In the above formula (2), Z preferably represents any one of functional groups represented by the below-indicated formulae. In the below-indicated formulae, examples of R include a methyl group, an ethyl group, an n-propyl group, an i-propyl group, an n-butyl group, an i-butyl group, and a t-butyl group.

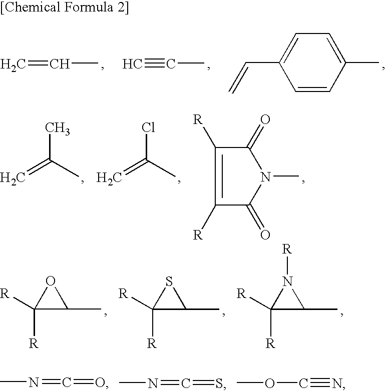

In the above formula (2), Sp preferably represents any one of structural units represented by the below-indicated formulae. In the below-indicated formulae, m preferably represents 1 to 3, and p preferably represents 1 to 12.

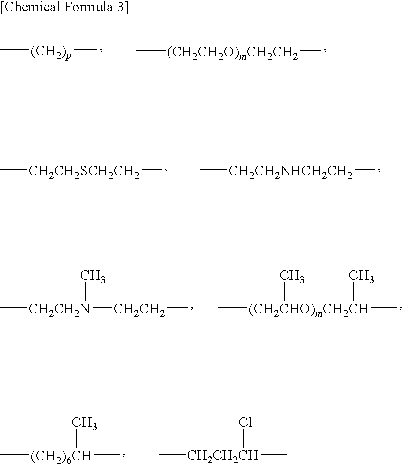

In the above formula (1), M is preferably represented by the below-indicated formula (3). In the below-indicated formula (3), X is the same as that defined in the above formula (1). Q represents a substituted or unsubstituted linear or branched alkylene group, or an aromatic hydrocarbon group, for example. Q may represent a substituted or unsubstituted linear or branched alkylene group having 1 to 12 carbon atoms, for example.

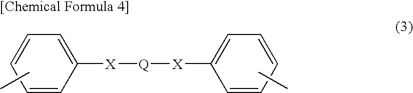

In the case where Q represents an aromatic hydrocarbon group, Q preferably represents anyone of aromatic hydrocarbon groups represented by the below-indicated formulae or substituted analogues thereof.

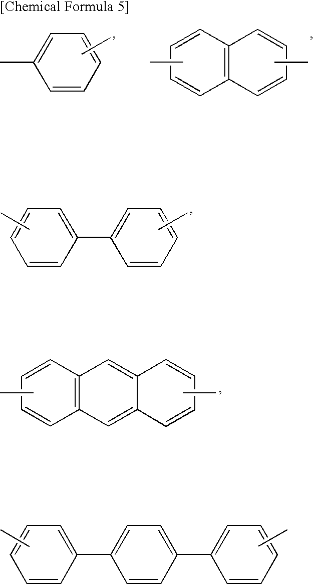

The substituted analogues of the aromatic hydrocarbon groups represented by the above formulae may each have 1 to 4 substituents per aromatic ring, or 1 to 2 substituents per aromatic ring or group. The substituents may be the same or different from each other. Examples of the substituents include: an alkyl group having 1 to 4 carbon atoms; a nitro group; a halogen group such as F, Cl, Br, or I; a phenyl group; and an alkoxy group having 1 to 4 carbon atoms.

Specific examples of the liquid crystal monomer include monomers represented by the following formulae (4) to (19).

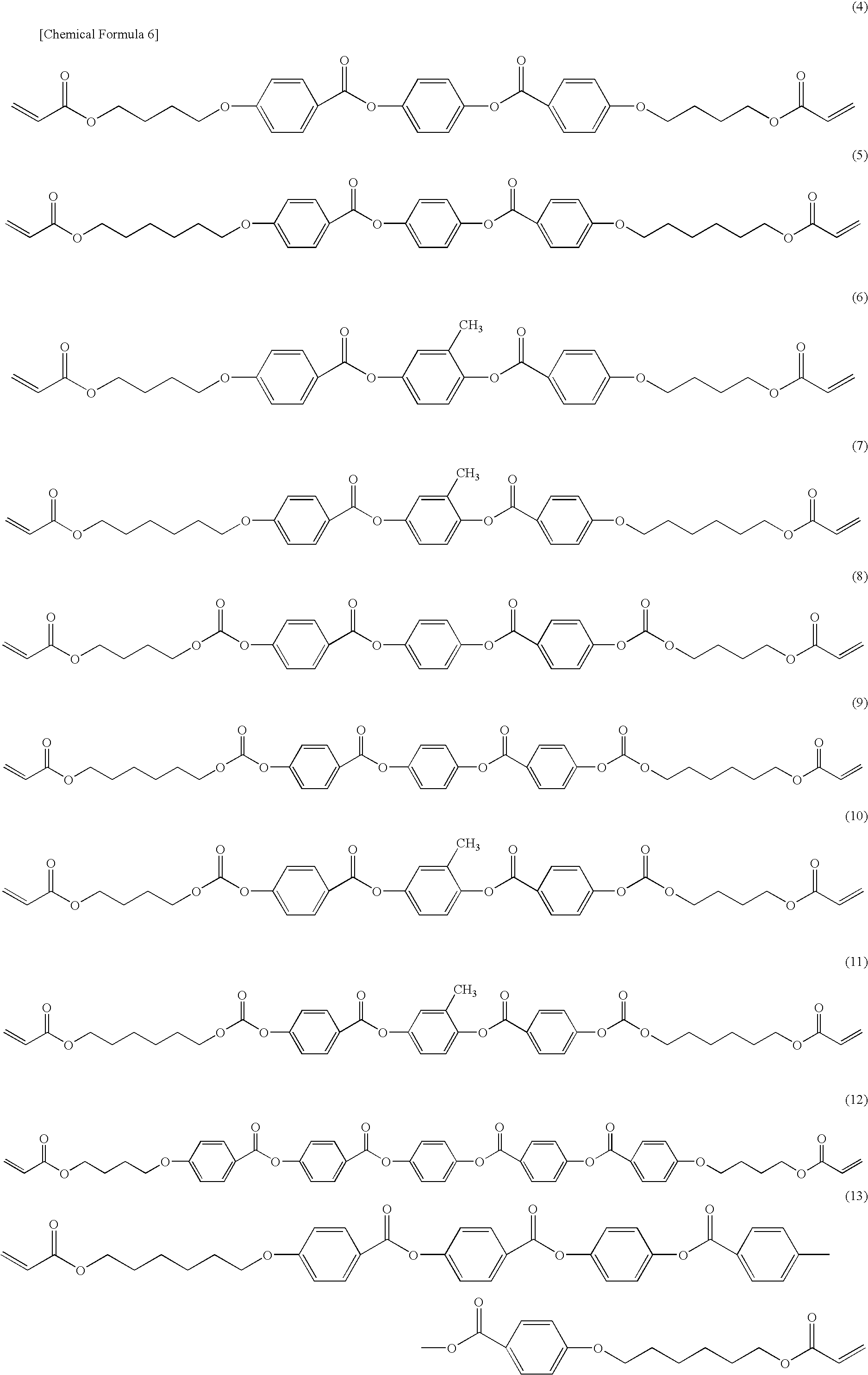

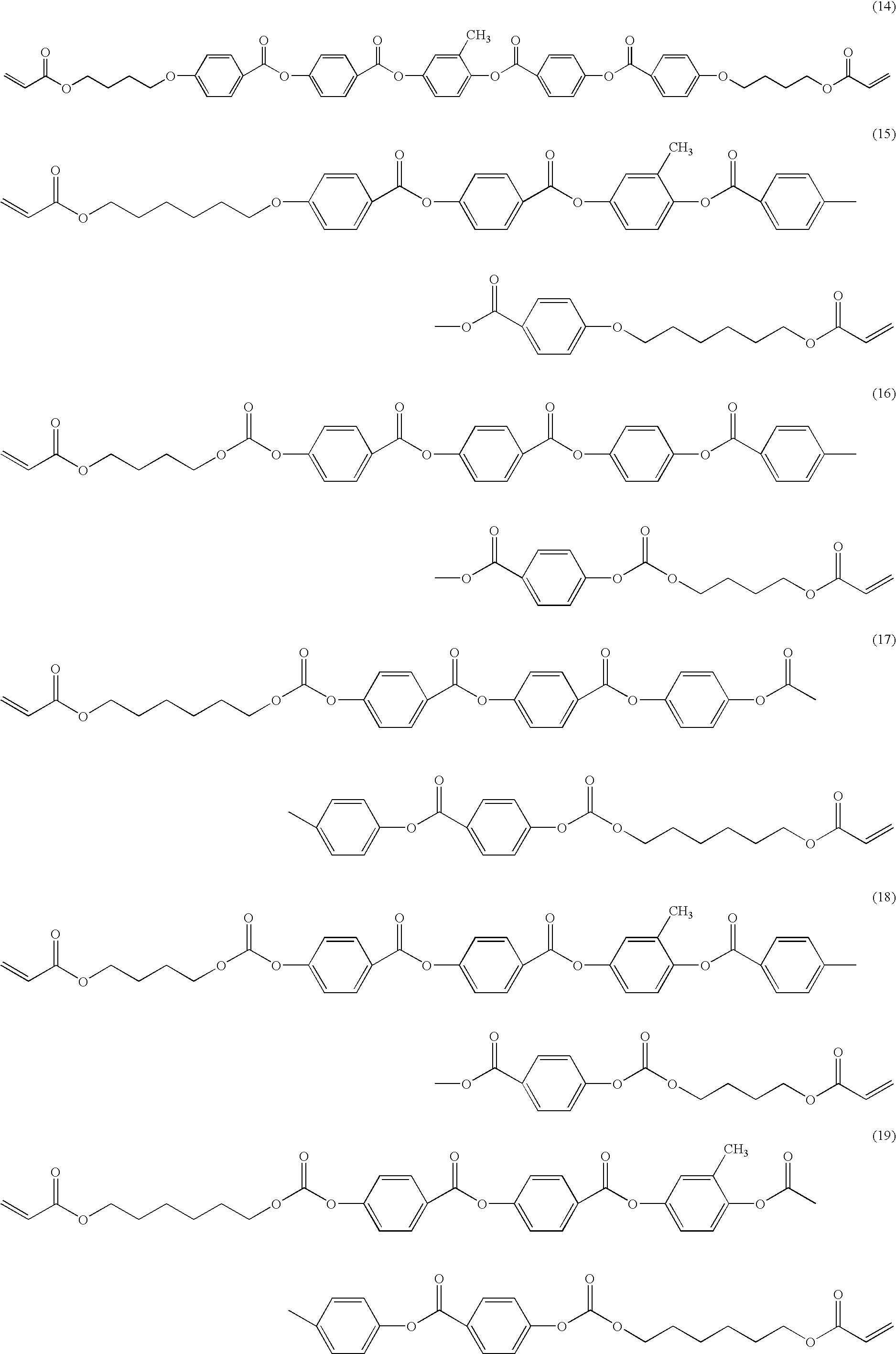

A temperature range in which the liquid crystal monomer exhibits liquid-crystallinity varies depending on the type of liquid crystal monomer. More specifically, the temperature range is preferably 40 to 120° C., more preferably 50 to 100° C., and most preferably 60 to 90° C.

### A-4-3. Liquid Crystal Composition Forming Third Optical Compensation Layer (Cholesteric Alignment Fixed Layer): Chiral Agent

The liquid crystal composition capable of forming the third optical compensation layer (cholesteric alignment fixed layer) preferably contains a chiral agent. A content of the chiral agent in the liquid crystal composition is preferably 5 to 23 wt %, and more preferably 10 to 20 wt %. In the case where the content of the chiral agent is less than 5 wt %, torsion cannot be sufficiently provided and thus the cholesteric alignment may not be formed sufficiently. As a result, a selective reflection wavelength region of the optical compensation layer to be obtained may be hardly controlled to a desired region (shorter wavelength side). In the case where the content of the chiral agent is more than 23 wt %, the liquid crystal material exhibits a liquid crystal state in a very narrow temperature range and a temperature during formation of an optical compensation layer must be controlled very accurately. As a result, production of a polarizing plate may involve difficulties. Such chiral agent may be used alone or in combination.

The chiral agent may employ any appropriate material capable of aligning the liquid crystal material into a desired cholesteric structure. For example, such a chiral agent has a torsional force of preferably 1×10⁻⁶ nm⁻¹·(wt %)⁻¹ or more, more preferably 1×10⁻⁵ nm⁻¹·(wt %)⁻¹ to 1×10⁻² nm⁻¹·(wt %)⁻¹, and most preferably 1×10⁻⁴ nm⁻¹·(wt %)⁻¹ to 1×10⁻³ nm⁻¹·(wt %)⁻¹. A chiral agent having such a torsional force may be used, to thereby control a helical pitch of the cholesteric alignment fixed layer within a desired range and control the selective reflection wavelength region within a desired range. For example, in the case where chiral agents of equal torsional force are used, a larger content of the chiral agent in the liquid crystal composition provides an optical compensation layer having a selective reflection wavelength region on a shorter wavelength side. For example, in the case where the content of the chiral agent in the liquid crystal composition is equal, a chiral agent having a larger torsional force provides an optical compensation layer having a selective reflection wavelength region on a shorter wavelength side. A specific example thereof is described below. For setting the selective reflection wavelength region of the optical compensation layer to be formed within a range of 200 to 220 nm, a liquid crystal composition may contain 11 to 13 wt % of a chiral agent having a torsional force of 5×10⁻⁴ nm⁻¹·(wt %)⁻¹, for example. For setting the selective reflection wavelength region of the optical compensation layer to be formed within a range of 290 to 310 nm, a liquid crystal composition may contain 7 to 9 wt % of a chiral agent having a torsional force of 5×10⁻⁴ nm⁻¹·(wt %)⁻¹, for example.

The chiral agent is preferably a polymerizable chiral agent. Specific examples of the polymerizable chiral agent include chiral compounds represented by the following general formulae (20) to (23).

(Z-X⁵)ₙCh (20)

(Z-X²-Sp-X⁵)ₙCh (21)

(P¹—X⁵)ₙCh (22)

(Z-X²-Sp-X³-M-X⁴)ₙCh (23)

In the formulae (20) to (23), Z and Sp are the same as those defined for the above formula (2). X², X³, and X⁴ each independently represent a chemical single bond, —O—, —S—, —O—CO—, —CO—O—, —O—CO—O—, —CO—NR—, —NR—CO—, —O—CO—NR—, —NR—CO—O—, or —NR—CO—NR—. R represents H or an alkyl group having 1 to 4 carbon atoms. X⁵ represents a chemical single bond, —O—, —S—, —O—CO—, —CO—O—, —O—CO—O—, —CO—NR—, —NR—CO—, —O—CO—NR—, —NR—CO—O—, —NR—CO—NR—, —CH₂O—, —O—CH₂—, —CH═N—, —N═CH—, or —N≡N—. R represents H or an alkyl group having 1 to 4 carbon atoms as described above. M represents a mesogenic group as described above. P¹ represents hydrogen, an alkyl group having 1 to 30 carbon atoms, an acyl group having 1 to 30 carbon atoms, or a cycloalkyl group having 3 to 8 carbon atoms which is substituted by 1 to 3 alkyl groups having 1 to 6 carbon atoms. n represents an integer of 1 to 6. Ch represents a chiral group with a valence of n. In the formula (23), at least one of X³ and X⁴ preferably represents —O—CO—O—, —O—CO—NR—, —NR—CO—O—, or —NR—CO—NR—. In the formula (22), in the case where P¹ represents an alkyl group, an acyl group, or a cycloalkyl group, its carbon chain may be interrupted by oxygen of an ether functional group, sulfur of a thioether functional group, a non-adjacent imino group, or an alkyl imino group having 1 to 4 carbon atoms.

Examples of the chiral group represented by Ch include atomic groups represented by the following formulae.

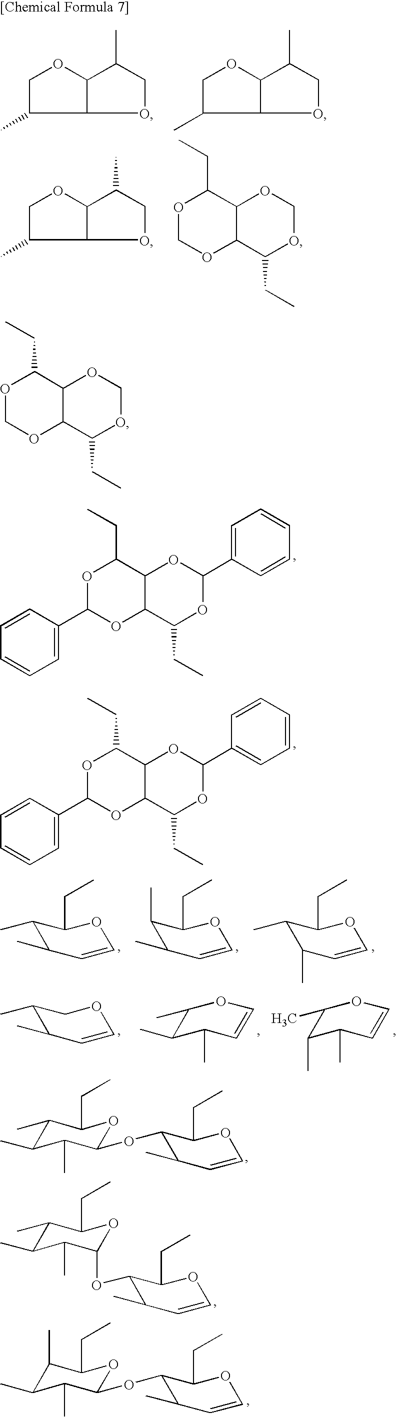

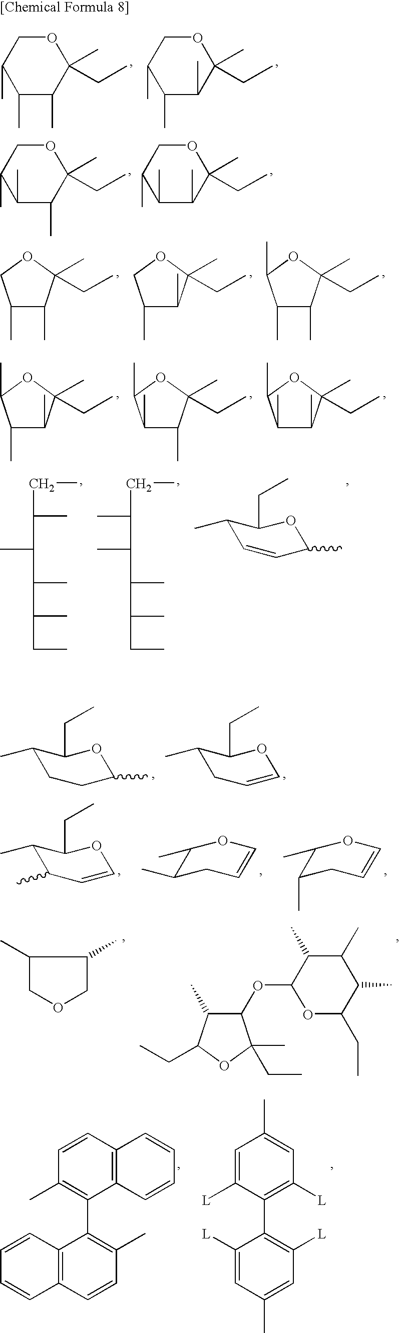

In the atomic groups described above, L represents an alkyl group having 1 to 4 carbon atoms, an alkoxy group having 1 to 4 carbon atoms, a halogen, COOR, OCOR, CONHR, or NHCOR. R represents an alkyl group having 1 to 4 carbon atoms. Note that terminals of the atomic groups represented in the above formulae each represent a bonding hand to an adjacent group.

Of the atomic groups, atomic groups represented by the following formulae are particularly preferred.

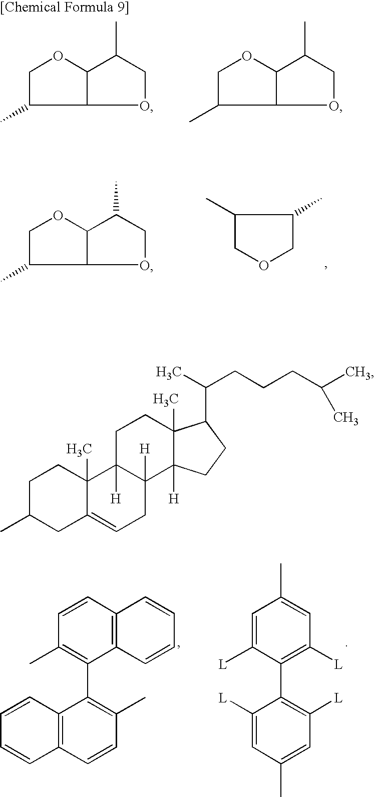

In a preferred example of the chiral compound represented by the above formula (21) or (23): n represents 2; Z represents H₂C═CH—; and Ch represents atomic groups represented by the following formulae.

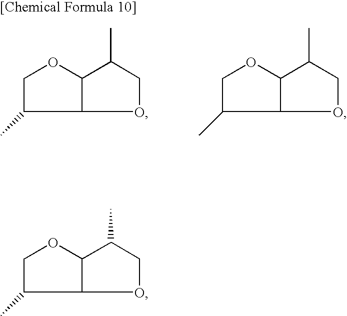

Specific examples of the chiral compound include compounds represented by the following formulae (24) to (44). Note that those chiral compounds each have a torsional force of 1×10⁻⁶ nm⁻¹·(wt %)⁻¹ or more.

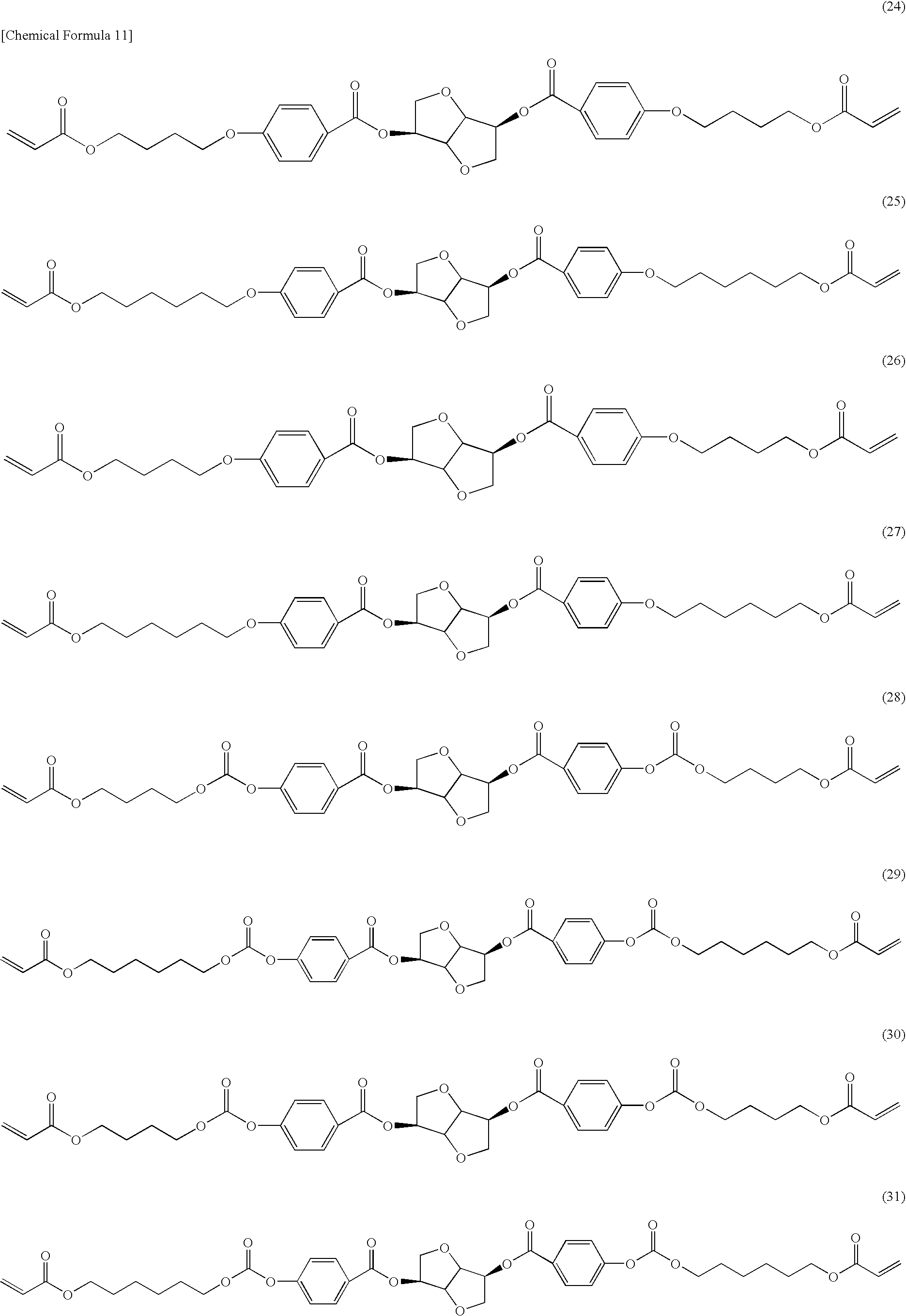

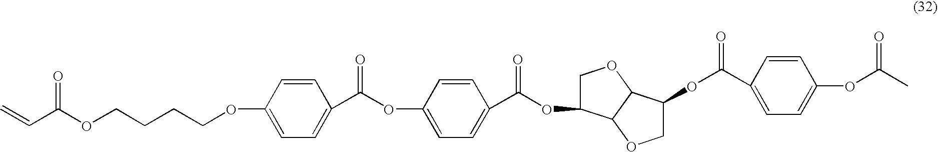

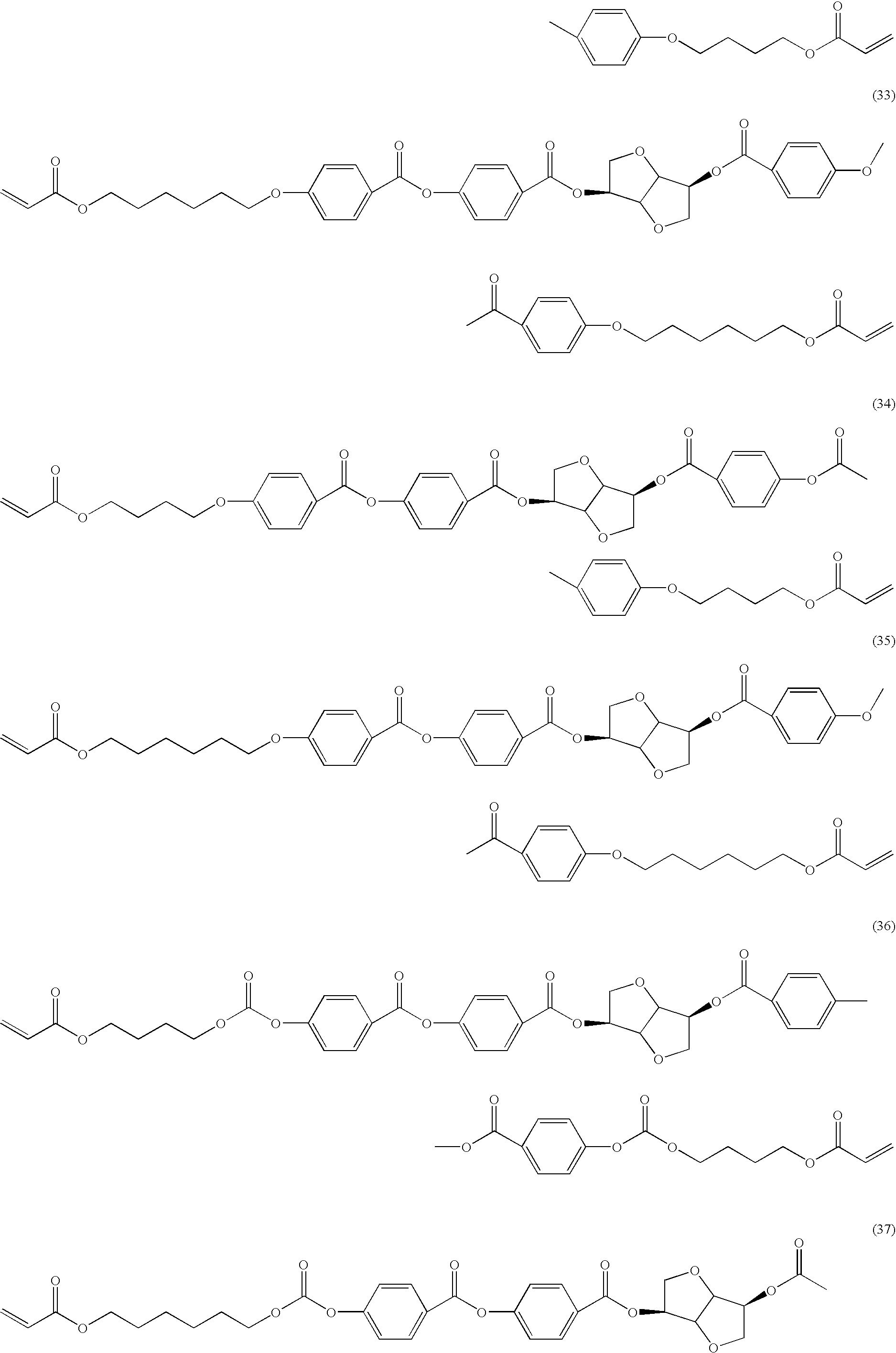

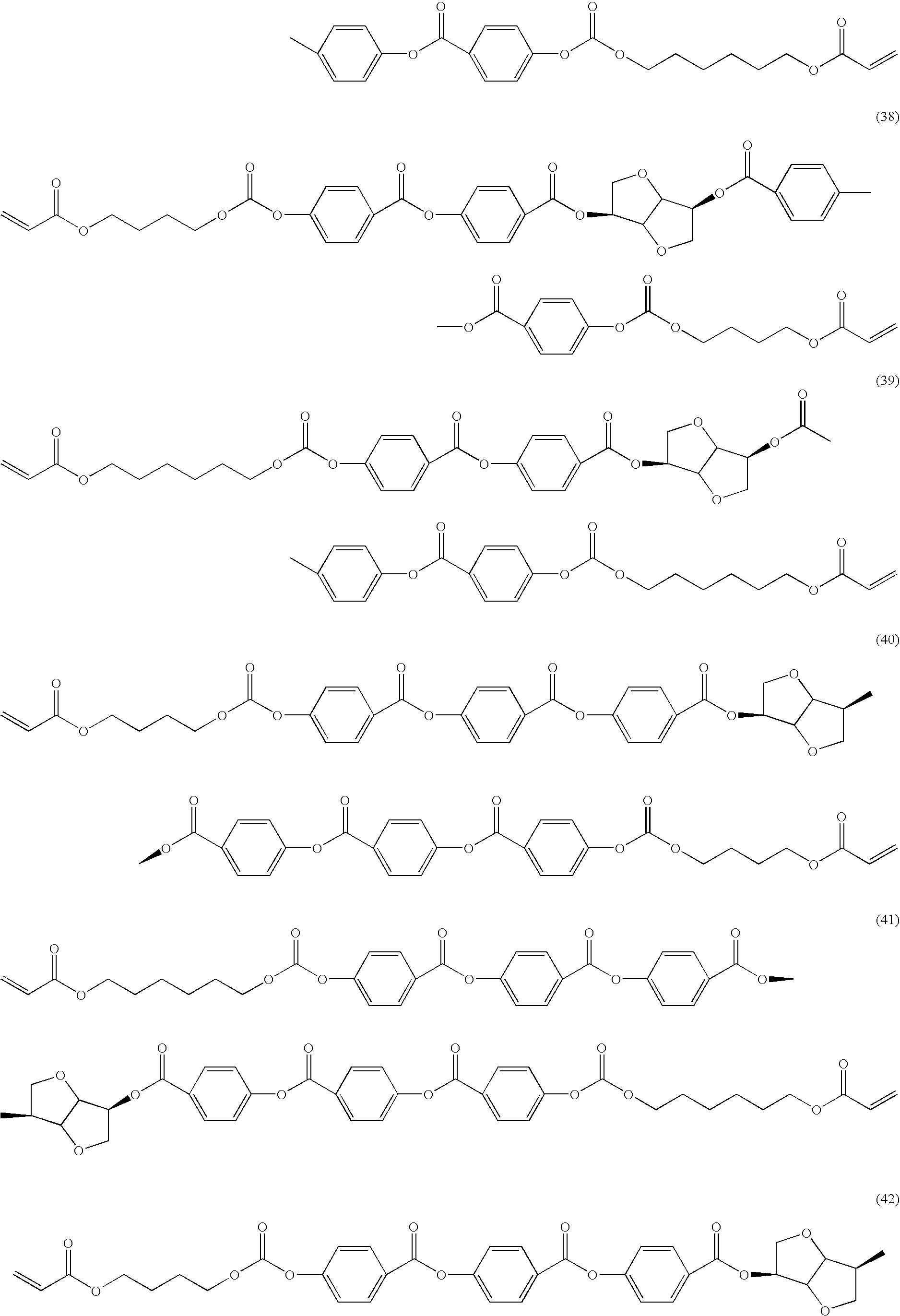

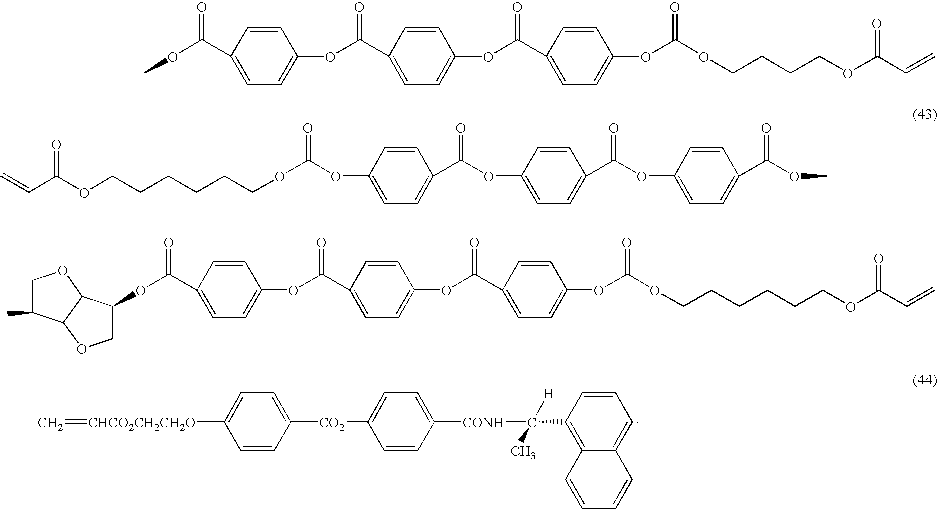

In addition to the chiral compounds represented above, further examples of the chiral compound include chiral compounds described in RE-A4342280, DE 19520660.6, and DE 19520704.1.

Note that any appropriate combination of the liquid crystal material and the chiral agent may be employed in accordance with the purpose. Particularly typical examples of the combination include: a combination of the liquid crystal monomer represented by the above formula (10)/the chiral agent represented by the above formula (38); and a combination of the liquid crystal monomer represented by the above formula (11)/the chiral agent represented by the above formula (39).

### A-4-4. Liquid Crystal Composition Forming Third Optical Compensation Layer (Cholesteric Alignment Fixed Layer): Other Additives

The liquid crystal composition capable of forming the third optical compensation layer (cholesteric alignment fixed layer) preferably contains at least one of a polymerization initiator and a crosslinking agent (curing agent). The polymerization initiator and/or the crosslinking agent (curing agent) is used, to thereby favorably fix the cholesteric structure (cholesteric alignment) of the liquid crystal material formed in a liquid crystal state. Any appropriate substance may be used for the polymerization initiator or the crosslinking agent as long as the effect of the present invention can be obtained. Examples of the polymerization initiator include benzoylperoxide (BPO) and azobisisobutyronitrile (AIBN). Examples of the crosslinking agent (curing agent) include a UV-curing agent, a photo-curing agent, and a heat-curing agent. Specific examples thereof include an isocyanate-based crosslinking agent, an epoxy-based crosslinking agent, and a metal chelate crosslinking agent. Such polymerization initiator or crosslinking agent may be used alone or in combination. A content of the polymerization initiator or the crosslinking agent in the liquid crystal composition is preferably 0.1 to 10 wt %, more preferably 0.5 to 8 wt %, and most preferably 1 to 5 wt %. In the case where the content of the polymerization initiator or the crosslinking agent is less than 0.1 wt %, the cholesteric structure may be fixed insufficiently. In the case where the content of the polymerization initiator or the crosslinking agent is more than 10 wt %, the liquid crystal material exhibits a liquid crystal state in a very narrow temperature range and temperature control during formation of an optical compensation layer may involve difficulties.

The liquid crystal composition may further contain any appropriate additive, as required. Examples of the additive include an antioxidant, modifier, surfactant, dye, pigment, discoloration inhibitor, and ultraviolet absorber. Those additives may be used alone or in combination. More specifically, examples of the antioxidant include a phenol-based compound, an amine-based compound, an organic sulfur-based compound, and a phosphine-based compound. Examples of the modifier include glycols, silicones, and alcohols. The surfactant is added, for example, in order to make the surface of an optical compensation layer smooth. Examples of the surfactant that can be used include a silicone-based surfactant, an acrylic surfactant, and a fluorine-based surfactant, and a silicone-based surfactant is particularly preferred.

### A-4-5. Method of Forming Third Optical Compensation Layer (Cholesteric Alignment Fixed Layer)

Any appropriate method may be employed for the method of forming the third optical compensation layer (cholesteric alignment fixed layer) as long as the desired cholesteric alignment fixed layer can be obtained. A typical method of forming the third optical compensation layer (cholesteric alignment fixed layer) involves: spreading the liquid crystal composition on a substrate to form a spread layer; subjecting the spread layer to heat treatment such that the liquid crystal material in the liquid crystal composition is aligned in cholesteric alignment; subjecting the spread layer to at least one of polymerization treatment and crosslinking treatment to fix the alignment of the liquid crystal material; and transferring the cholesteric alignment fixed layer formed on the substrate. Hereinafter, a specific procedure for the method of forming the third optical compensation layer is described.

First, a liquid crystal material, a chiral agent, a polymerization initiator or a crosslinking agent, and various additives as required are dissolved or dispersed into a solvent to prepare a liquid crystal application liquid. The liquid crystal material, the chiral agent, the polymerization initiator, the crosslinking agent, and the additive are as described above. A solvent to be used in the liquid crystal application liquid is not particularly limited. Specific example thereof includes: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, methoxybenzene, and 1,2-dimethoxybenzene; ketone-based solvents such as acetone, methylethylketone (MEK), methylisobutylketone, cyclohexanone, cyclopentanone, 2-pyrolidone, and N-methyl-2-pyrolidone; ester-based solvents such as ethyl acetate and butyl acetate; alcohol-based solvents such as t-butyl alcohol, glycerin, ethylene glycol, triethylene glycol, ethylene glycol monomethylether, diethylene glycol dimethylether, propylene glycol, dipropylene glycol, and 2-methyl-2,4-pentanediol; amide-based solvents such as dimethylformamide and dimethylacetoamide; nitrile-based solvents such as acetonitrile and butyronitrile; ether-based solvents such as diethylether, dibutylether, tetrahydroflan, and dioxane; carbon disufide; ethyl cellosolve; and butyl cellosolve. Of those, toluene, xylene, mesitylene, MEK, methyl isobutylketone, cyclohexanone, ethyl cellosolve, butyl cellosolve, ethyl acetate, butyl acetate, propyl acetate, and ethyl cellosolve acetate are preferred. Those solvents may be used alone or in combination.

A viscosity of the liquid crystal application liquid may vary depending on the content of the liquid crystal material or temperature. For example, in the case where a concentration of the liquid crystal material in the liquid crystal application liquid is 5 to 70 wt % at about room temperature (20 to 30° C.), the viscosity of the application liquid is preferably 0.2 to 20 mPa·s, more preferably 0.5 to 15 mPa·s, and most preferably 1 to 10 mPa·s. To be more specific, in the case where the concentration of the liquid crystal material in the liquid crystal application liquid is 30 wt %, the viscosity of the application liquid is preferably 2 to 5 mPa·s, and more preferably 3 to 4 mPa·s. The application liquid having a viscosity of 0.2 mPa·s or more can favorably prevent generation of liquid drip due to spreading of the application liquid. Further, the application liquid having a viscosity of 20 mPa·s or less can provide an optical compensation layer having very excellent surface smoothness without uneven thickness and excellent application property.

Next, the liquid crystal application liquid is applied onto the substrate to form a spread layer. The method of forming the spread layer may employ any appropriate method (typically, method of fluid spreading the application liquid). Specific examples thereof include a roll coating method, a spin coating method, a wire bar coating method, a dip coating method, an extrusion coating method, a curtain coating method, and a spray coating method. Of those, the spin coating method and the extrusion coating method are preferred from the viewpoint of coating efficiency.

An application amount of the liquid crystal application liquid may appropriately be set in accordance with the concentration of the application liquid, the thickness of the intended layer, and the like. For example, in the case where the concentration of the liquid crystal material in the application liquid is 20 wt %, the application amount is preferably 0.03 to 0.17 ml, more preferably 0.05 to 0.15 ml, and most preferably 0.08 to 0.12 ml per area (100 cm²) of the substrate.

Any appropriate substrate capable of aligning the liquid crystal material may be used as the substrate. Typically, the substrate includes various plastic films. Specific examples of the plastic include cellulose-based plastics such as triacetyl cellulose (TAC), polyolefin such as polyethylene, polypropylene or poly(4-methylpentene-1), polyimide, polyamideimide, polyether imide, polyamide, polyetheretherketone, polyetherketone, polyketone sulfide, polyethersulfone, polysulfone, polyphenylene sulfide, polyphenylene oxide, polyethylene terephthalate, polybutylene terephthalate, polyethylene naphthalate, polyacetal, polycarbonate, polyarylate, an acrylic resin, polyvinyl alcohol, polypropylene, an epoxy resin, and a phenol-resin. Further, a substrate in that a plastic film or sheet as described above is placed on the surface of, for example, a substrate made of metal such as aluminum, copper, or iron, a substrate made of ceramic, or a substrate made of glass can also be used. Furthermore, a substrate obtained by forming an SiO₂ oblique evaporation film on the surface of the plastic film or sheet can also be used. The thickness of a substrate is preferably 5 μm to 500 μm, more preferably 10 μm to 200 μm, and most preferably 15 μm to 150 μm. Such thickness provides sufficient strength for a substrate, and thus can prevent the generation of problems, for example, breaking upon manufacture.

Next, the spread layer is subjected to heat treatment to align the liquid crystal material in a state exhibiting a liquid crystal phase. The spread layer contains a chiral agent together with the liquid crystal material, and thus the liquid crystal material provided with torsion in a state exhibiting a liquid crystal phase is aligned. As a result, the spread layer (liquid crystal material forming the spread layer) forms the cholesteric structure (helical structure).

The temperature conditions for the heat treatment may appropriately be set in accordance with the type of liquid crystal material (specifically, temperature at which the liquid crystal material exhibits liquid crystallinity). To be more specific, the heating temperature is preferably 40 to 120° C., more preferably 50 to 100° C., and most preferably 60 to 90° C. A heating temperature of 40° C. or higher generally allows sufficient alignment of the liquid crystal material. A heating temperature of 120° C. or lower expands selection of the substrate in consideration of heat resistance, for example, and thus allows selection of an optimal substrate in accordance with the liquid crystal material. Further, a heating time is preferably 30 seconds or more, more preferably 1 minute or more, particularly preferably 2 minutes or more, and most preferably 4 minutes or more. In the case where a treatment time is less than 30 seconds, the liquid crystal material may not sufficiently exhibit a liquid crystal state. Further, the heating time is preferably 10 minutes or less, more preferably 8 minutes or less, and most preferably 7 minutes or less. In the case where the treatment time is more than 10 minutes, the additives may be sublimed.

Next, the spread layer containing the liquid crystal material exhibiting a cholesteric structure is subjected to at least one of polymerization treatment and crosslinking treatment to fix the alignment (cholesteric structure) of the liquid crystal material. To be more specific, the polymerization treatment is performed, to thereby polymerize the liquid crystal material (polymerizable monomer) and/or chiral agent (polymerizable chiral agent) and fix the polymerizable monomer and/or polymerizable chiral agent as a repeating unit of polymer molecules. Further, the crosslinking treatment is preformed, to thereby form a three-dimensional network structure of the liquid crystal material (crosslinking monomer) and/or chiral agent and fix the crosslinking monomer and/or chiral agent as apart of a crosslinked structure. As a result, an alignment state of the liquid crystal material is fixed. Note that the polymer or three-dimensional network structure to be formed through polymerization or crosslinking of the liquid crystal material is “non-liquid crystalline”. The thus-formed third optical compensation layer does not transfer into a liquid crystal phase, glass phase, or crystal phase due to temperature change unique to a liquid crystal compound, for example, and no alignment change due to temperature occurs. As a result, the thus-formed third optical compensation layer may be used as a high performance optical compensation layer not affected by the temperature change. The third optical compensation layer has a selective reflection wavelength region optimized within a range of 100 nm to 320 nm, and thus can significantly suppress light leak and the like.

A specific procedure for the polymerization treatment or crosslinking treatment may appropriately be selected in accordance with the type of polymerization initiator or crosslinking agent to be used. For example, a photo-polymerization initiator or photo-crosslinking agent may be used for photoirradiation. A UV polymerization initiator or UV crosslinking agent may be used for UV irradiation, and heat polymerization initiator or heat crosslinking agent may be used for heating. The irradiation time of light or UV light, the irradiation intensity, the total irradiation amount, and the like may appropriately be set in accordance with the type of liquid crystal material, the type of substrate, properties desired for the third optical compensation layer, and the like. Similarly, the heating temperature, the heating time, and the like may appropriately be set in accordance with the purpose.

The cholesteric alignment fixed layer formed on the substrate as described above is transferred onto a surface of the second optical compensation layer to form the third optical compensation layer. In the case where the third optical compensation layer has a laminate structure of the cholesteric alignment fixed layer and the plastic film layer, the plastic film layer may be attached to the second optical compensation layer through a pressure-sensitive adhesive layer and the cholesteric alignment fixed layer may be transferred to the plastic layer, to thereby form the third optical compensation layer. Alternatively, the plastic film layer may be attached to the cholesteric alignment fixed layer formed on the substrate through an adhesive layer to form a laminate, and the laminate may be attached to the surface of the second optical compensation layer through a pressure-sensitive adhesive layer. The transfer step further includes peeling the substrate from the third optical compensation layer. The curable adhesive for the adhesive layer is as described in the above section A-3. The plastic film layer is as described in the above section A-4.

The above-mentioned typical example of the method of forming the third optical compensation layer employs a liquid crystal monomer (polymerizable monomer or crosslinking monomer, for example) as the liquid crystal material, but the method of forming the third optical compensation layer of the present invention is not limited to such a method and may be a method which employs a liquid crystalline polymer. However, the method preferably employs a liquid crystal monomer as described above. The liquid crystal monomer may be used, to thereby form an optical compensation layer having an excellent optical compensation function and reduced thickness. To be specific, use of the liquid crystal monomer facilitates control of the selective reflection wavelength region. Further, the viscosity of the application liquid and the like may easily be set by using the liquid crystal monomer, to thereby facilitate formation of a extremely thin third optical compensation layer. Further, the liquid crystal monomer has excellent handling property. In addition, the optical compensation layer to be obtained has even better surface smoothness.

A-5. Polarizer

As the polarizer 11, any suitable polarizers may be employed as the polarizer depending on the purpose. Examples of the polarizer include: a film prepared by adsorbing a dichromatic substance such as iodine or a dichromatic dye on a hydrophilic polymer film such as a polyvinyl alcohol-based film, a partially formalized polyvinyl alcohol-based film, or an ethylene/vinyl acetate copolymer-based partially saponified film and uniaxially stretching the film; and a polyene-based orientated film such as a dehydrated product of a polyvinyl alcohol-based film or a dichlorinated product of a polyvinyl chloride-based film. Of those, a polarizer prepared by adsorbing a dichromatic substance such as iodine on a polyvinyl alcohol-based film and uniaxially stretching the film is particularly preferred in view of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washing away of an antiblocking agent, but also prevents nonuniformity such as uneven coloring or the like by swelling the polyvinyl alcohol-based film. The stretching of the film may be carried out after coloring of the film with iodine, carried out during coloring of the film, or carried out followed by coloring of the film with iodine. The stretching may be carried out in an aqueous solution of boric acid or potassium iodide, or in a water bath.

A-6. Protective Film

As the protective film, any appropriate film which can be used as a protective film for a polarizer may be employed. Specific examples of a material used as a main component of the film include transparent resins such as a cellulose-based resin (such as triacetylcellulose (TAC)), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, an acrylic resin, and an acetate-based resin. Another example thereof includes an acrylic, urethane-based, acrylic urethane-based, epoxy-based, or silicone-based thermosetting resin or UV-curing resin. Still another example thereof includes a glassy polymer such as a siloxane-based polymer. Further, a polymer film described in JP 2001-343529 A (WO 01/37007) may also be used. To be specific, the film is formed of a resin composition containing a thermoplastic resin having a substituted or unsubstituted imide group on a side chain, and a thermoplastic resin having a substituted or unsubstituted phenyl group and a nitrile group on a side chain. A specific example thereof includes a resin composition containing an alternate copolymer of isobutene and N-methylmaleimide, and an acrylonitrile/styrene copolymer. The polymer film may be an extruded product of the above-mentioned resin composition, for example. Of those, TAC, a polyimide-based resin, a polyvinyl alcohol-based resin, and a glassy polymer are preferable, and TAC is more preferable.

It is preferable that the protective layer be transparent and have no color. To be specific, the protective layer has a thickness direction retardation of preferably −90 nm to +90 nm, more preferably −80 nm to +80 nm, and most preferably −70 nm to +70 nm.

The protective layer has any appropriate thickness as long as the preferable thickness direction retardation can be obtained. To be specific, the thickness of the protective layer is preferably 5 mm or less, more preferably 1 mm or less, particularly preferable 1 to 500 μm, and most preferably 5 to 150 μm.

The protective film provided on the outer side of the polarizer 11 (that is, the opposite side to the optical compensation layer) may be subjected to hard coat treatment, antireflection treatment, anti-sticking treatment, anti-glare treatment, or the like as required.

A-7. Other Structural Components of Polarizing Plate

The polarizing plate with an optical compensation layer of the present invention may be provided with other optical layers. As the other optical layers, any appropriate optical layers may be employed in accordance with the purpose and the types of image display apparatus. Specific examples thereof include a liquid crystal film, a light scattering film, a diffraction film, and another optical compensation layer (retardation film).

The polarizing plate with an optical compensation layer of the present invention may further include a pressure-sensitive adhesive layer or adhesive layer as an outermost layer on at least one side thereof. In this way, the polarizing plate includes the pressure-sensitive adhesive layer or adhesive layer as an outermost layer, to thereby facilitate lamination with another member (for example, liquid crystal cell) and prevent the polarizing plate from peeling off from another member. Any appropriate materials may be used as the material for forming the pressure-sensitive adhesive layer. Specific examples of the pressure-sensitive adhesive are described in the item A-2. Specific examples of the adhesive layer are described in the item A-3. Preferably, a material having excellent moisture absorption property or excellent heat resistance is used, for preventing foaming or peeling due to moisture absorption, degradation in optical properties due to difference in thermal expansion or the like, warping of the liquid crystal cell, and the like.

For practical use, a surface of the pressure-sensitive adhesive layer or adhesive layer is covered by any appropriate separator to prevent contamination until the polarizing plate is actually used. The separator may be formed by a method of providing a release coat on any appropriate film by using a releasing agent such as a silicone-based, long chain alkyl-based, or fluorine-based, or molybdenum sulfide as required.

Each of the layers of the polarizing plate with an optical compensation layer of the present invention may be subjected to treatment with a UV absorbing agent such as a salicylic ester-based compound, a benzophenone-based compound, a benzotriazole-based compound, a cyanoacrylate-based compound, or a nickel complex salt-based compound, to thereby impart UV absorbing property.

B. Method of Producing a Polarizing Plate

The polarizing plate with an optical compensation layer of the present invention may be produced by laminating each of the layers via the adhesive layer or the pressure-sensitive adhesive layer. As laminating means, any suitable means can be employed as long as each angle formed by optical axes of each layer (the angles α, β, and γ) falls within the above ranges. For example, the polarizer, the first optical compensation layer, the second optical compensation layer, and the third optical compensation layer are punched to a predetermined size, and the directions of angles (α, β, and γ) formed by optical axes of respective layers are adjusted to be in a desired range, whereby the layers can be laminated via an adhesive or a pressure-sensitive adhesive.

C. Application Purposes of Polarizing Plate

The polarizing plate with an optical compensation layer of the present invention may suitably be used for various image display apparatuses (for example, a liquid crystal display apparatus and a self-luminous display apparatus). Specific examples of applicable image display apparatuses include a liquid crystal display apparatus, an EL display, a plasma display (PD), and a field emission display (FED). In the case where the polarizing plate with an optical compensation layer of the present invention is used for a liquid crystal display apparatus, the polarizing plate with an optical compensation layer is useful for prevention of light leakage in black display and for compensation of viewing angle. The polarizing plate with an optical compensation layer of the present invention is preferably used for a liquid crystal display apparatus of a VA mode, and is particularly preferably used for a reflection-type or semi-transmission-type liquid crystal display apparatus of a VA mode. In the case where the polarizing plate with an optical compensation layer of the present invention is used for an EL display, the polarizing plate with an optical compensation layer is useful for prevention of electrode reflection.

D. Image Display Apparatus

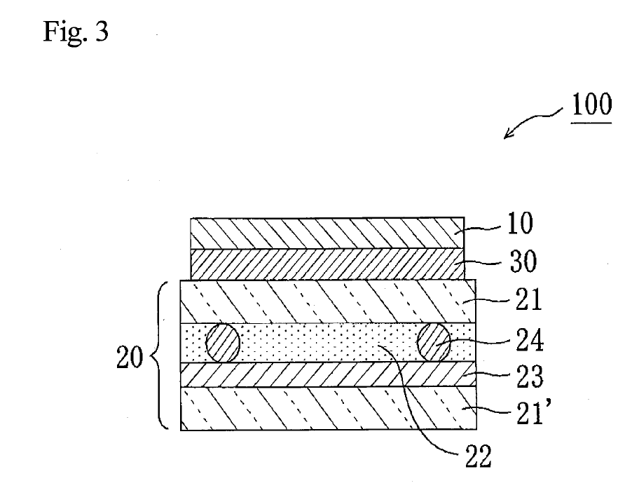

As an example of the image display apparatus of the present invention, a liquid crystal display apparatus will be described. Herein, a-liquid crystal panel used in a liquid crystal display apparatus will be described. As the configurations of the liquid crystal display apparatus and the other components, any suitable configurations can be employed depending upon the purpose. In the present invention, a liquid crystal display apparatus of a VA mode is preferred, and a reflection-type and semi-transmission-type liquid crystal display apparatus of a VA mode is particularly preferred. FIG. 3 is a schematic cross-sectional view of a liquid crystal panel of a preferred embodiment of the present invention. Herein, a liquid crystal panel for a reflective liquid crystal display apparatus will be described. A liquid crystal panel 100 has a liquid crystal cell 20, a retardation plate 30 placed on an upper side of the liquid crystal cell 20, and a polarizing plate 10 placed on an upper side of the retardation plate 30. As the retardation plate 30, any suitable retardation plate can be employed depending upon the purpose and the alignment mode of the liquid crystal cell. The retardation plate 30 can be omitted depending upon the purpose and the alignment mode of the liquid crystal cell. The polarizing plate 10 is a polarizing plate with an optical compensation layer of the present invention, described in items A and B above. The liquid crystal cell 20 includes a pair of glass substrates 21, 21′, and a liquid crystal layer 22 as a display medium placed between the substrates. A reflective electrode 23 is provided on the liquid crystal layer 22 side of the lower substrate 21′. A color filter (not shown) is provided on the upper substrate 21. An interval (cell gap) between the substrates 21, 21′ is controlled by spacers 24.

For example, in the case of a reflection-type VA mode, in the liquid crystal display apparatus 100, liquid crystal molecules are aligned perpendicularly with respect to the surfaces of the substrates 21, 21′ under no voltage application. Such vertical alignment can be realized by placing nematic liquid crystal having negative dielectric anisotropy between substrates on which a vertical alignment film (not shown) is formed. When linearly polarized light having passed through the polarizing plate 10 enters the liquid crystal layer 22 from the surface of the upper substrate 21 in this state, the incident light advances along a longitudinal axis direction of the liquid crystal molecules aligned perpendicularly. Because the birefringence does not occur in the longitudinal axis direction of the liquid crystal molecules, the incident light advances without changing a polarization direction. The incident light is reflected by the reflective electrode 23 and passes again through the liquid crystal layer 22 to be output from the upper substrate 21. The polarization state of the output light does not change from the one during incidence, so the output light is transmitted through the polarizing plate 10, and a display in a bright state is obtained. When a voltage is applied between the electrodes, the longitudinal axis of the liquid crystal molecules is aligned in parallel with the substrate surface. The liquid crystal molecules exhibit birefringence with respect to the linearly polarized light that enters the liquid crystal layer 22 in this state, and the polarization state of the incident light changes depending upon the inclination of the liquid crystal molecules. During the application of a predetermined maximum voltage, the light reflected by the reflective electrode 23 and output from the upper substrate becomes linear polarized light, for example, with its polarization direction rotated by 90°, and is absorbed by the polarizing plate 10, whereby a display in a dark state is obtained. When the application of a voltage is cancelled, the state can be returned to a display in a bright state by an alignment regulating force. Further, the inclination of the liquid crystal molecules is controlled by changing an applied voltage to change the intensity of transmitted light from the polarizing plate 10, whereby display of gradation can be performed.

Hereinafter, the present invention will be described more specifically by way of examples. It should be noted that the present invention is not limited to these examples. The method of measuring each property in the examples is as follows.

(1) Measurement of a Thickness

The thicknesses of polarizing plates with an optical compensation layer in examples and comparative examples were measured using a dial gauge manufactured by OZAKI MFG. Co., Ltd.

(2) Measurement of Heat Unevenness

Regarding the polarizing plates with an optical compensation layer obtained in examples and comparative examples, the same polarizing plates with an optical compensation layer were attached to each other to produce a measurement sample. The attachment was performed so that absorption axes of polarizers were perpendicular to each other, and the third optical compensation layers were opposed to each other. The measurement sample was placed on a backlight, and an image irradiated with light from a backlight was photographed with a digital camera. The photographed image was grayed (256 gray-scale), using Win Roof v3.0 manufactured by Mitani Corporation. The 35th gray-scale of the brightness gray-scale 0-255 was set to be a threshold value, and 0-35 and 35-255 were set to be white and black, respectively, so the gray-scale is converted to be binary. The white ratio in the image was expressed by %. The measurement sample was heated at 85° C. for 10 minutes, and the white ratio before and after heating was measured, whereby the change amount thereof was obtained. This shows that heat unevenness is smaller if the change amount is smaller.

(3) Measurement of a Transmittance

Regarding the polarizing plates with an optical compensation layer obtained in the examples and the comparative examples, the same polarizing plates with an optical compensation layer were attached to each other to produce a measurement sample. The attachment was performed so that absorption axes of polarizers were perpendicular to each other, and the third optical compensation layers were opposed to each other. The transmittance of the measurement sample was measured by DOT-3 (trade name) (manufactured by Murakami Color Research Laboratory Co., Ltd.).

(4) Measurement of Heat Unevenness During Mounting of a Liquid Crystal Cell

The polarizing plate with an optical compensation layer obtained in the examples and the comparative examples was attached to a viewer side of a VA mode liquid crystal cell (obtained from a mobile telephone SH901 is manufactured by Sharp Corporation) via an acrylic pressure-sensitive adhesive (thickness: 20 μm), whereby a measurement sample was produced. At this time, the attachment was performed so that the third optical compensation layer was placed on a liquid crystal cell side. Heat unevenness was measured by the same method as that in the item (2), except that the measurement sample was produced as described above.

(Production of a Polarizer)

A commercially available polyvinyl alcohol (PVA) film (manufactured by Kurary Co., Ltd.) was dyed in an aqueous solution containing iodine, and uniaxially stretched about 6 times between rolls with different speeds in an aqueous solution containing boric acid, whereby a long polarizer was obtained. Commercially available TAC films (manufactured by Fujiphoto Film Co., Ltd.) were attached to both surfaces of the polarizer with a PVA-based adhesive, whereby a polarizing plate (protective film/polarizer/protective film) with an entire thickness of 100 μm was obtained. The polarizing plate was punched to a size of 20 cm (longitudinal direction)×30 cm (lateral direction) so that the absorption axis of the polarizer was placed in a longitudinal direction.

(Production of a First Optical Compensation Layer)

A long norbornene based resin film (Zeonor (trade name) manufactured by Zeon Corporation, thickness: 60 μm, photoelastic coefficient: 3.10×10⁻¹² m²/N) was uniaxially stretched 1.90 times at 140° C., whereby a long film for a first optical compensation layer was produced. The thickness of the film was 45 μm, and the in-plane retardation Re₁ was 270 nm. The film was punched to a size of 20 cm (longitudinal direction)×30 cm (lateral direction). At this time, the slow axis was placed in a longitudinal direction.

(Production of a Second Optical Compensation Layer)

A long norbornene based resin film (Zeonor (trade name) manufactured by Zeon Corporation, thickness: 60 μm, photoelastic coefficient: 3.10×10⁻¹² m²/N) was uniaxially stretched 1.32 times at 140° C., whereby a long film for a second optical compensation layer was produced. The thickness of the film was 50 μm, and the in-plane retardation Re₂ was 140 nm. The film was punched to a size of 20 cm (longitudinal direction)×30 cm (lateral direction). At this time, the slow axis was placed in a longitudinal direction.

(Production of a Third Optical Compensation Layer)

90 parts by weight of a nematic liquid crystalline compound represented by the following Formula (10), 10 parts by weight of a chiral agent represented by the following Formula (38), 5 parts by weight of a photopolymerization initiator (Irgacure 907 manufactured by Ciba Specialty Chemicals Inc.), and 300 parts by weight of methyl ethyl ketone were mixed uniformly, whereby a liquid crystal application liquid was prepared. The liquid crystal application liquid was applied to a substrate (biaxially stretched PET film), heated at 80° C. for 3 minutes, and polymerized by the irradiation of UV-light, whereby a third optical compensation layer was formed. The substrate with the third optical compensation layer formed thereon was punched to a size of 20 cm (longitudinal direction)×30 cm (lateral direction). The thickness of the third optical compensation layer was 2 μm, the in-plane retardation Re₃ was 0 nm, and the thickness direction retardation Rth₃ was 110 nm.

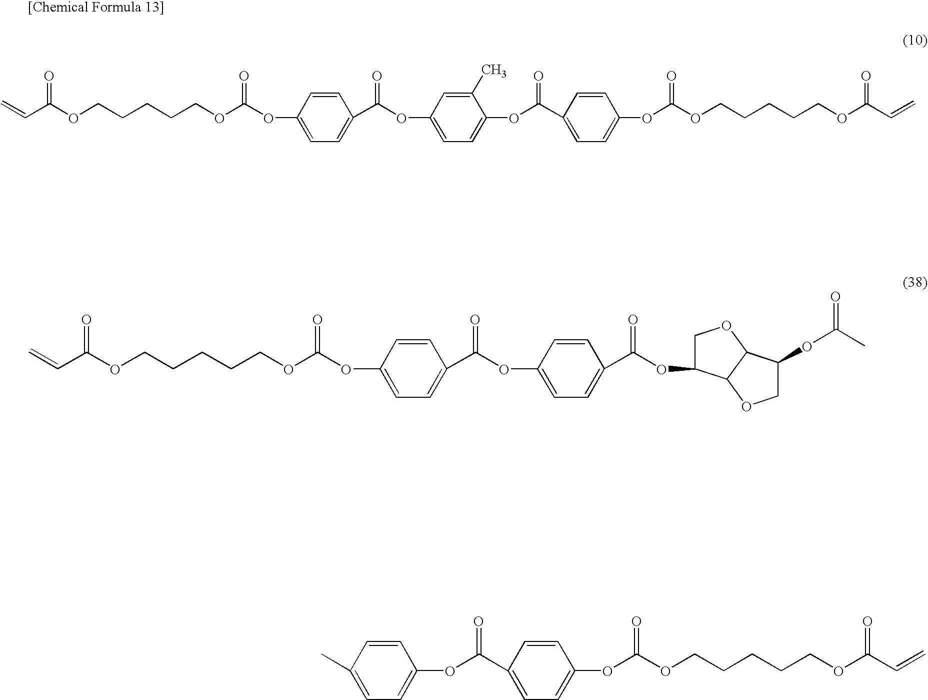

(Preparation of a Pressure-Sensitive Adhesive X)

To a reaction container equipped with a cooling tube, a nitrogen introduction tube, a thermometer, and a stirring device, 99 parts by weight of butyl acrylate, 1.0 part by weight of 4-hydroxylbutyl acrylate, and 0.3 parts by weight of 2,2′-azobisisobutylonitrile were added together with ethyl acetate, and the mixture was reacted under the stream of a nitrogen gas at 60° C. for 4 hours. After that, ethyl acetate was added to the reaction solution to obtain a solution (concentration of a solid content: 30% by weight) containing an acrylic base polymer having a weight average molecular weight of 1,650,000. With respect to 100 parts by weight of a solid content of the acrylic base polymer solution, 0.15 parts by weight of dibenzoylperoxide (Nyper-BO-Y (trade name) manufactured by NOF Corporation), 0.02 parts by weight of trimethylolpropane xylenediisocyanate (Takenate D110N (trade name) manufactured by Mitsui Chemicals Polyurethanes, Inc.), and 0.2 parts by weight of a silane coupling agent containing an acetoacetyl group (A-100 (trade name) manufactured by Soken Chemicals & Engineering Co., Ltd.) were blended to obtain a pressure-sensitive adhesive. A dynamic storage shear modulus (G′) at 100° C. of the obtained pressure-sensitive adhesive was measured to be 5×10⁴ Pa.

(Production of a Polarizing Plate with an Optical Compensation Layer)

The polarizing plate, the first optical compensation layer, the second optical compensation layer, and the third optical compensation layer obtained above were laminated in the stated order. Herein, they were laminated so that slow axes of the first optical compensation layer and the second optical compensation layer formed angles of 15° and 75°, respectively, in a counterclockwise direction with respect to the absorption axis of the polarizer of the polarizing plate. The polarizing plate and the first optical compensation layer were laminated using the pressure-sensitive adhesive X (thickness: 23 μm) obtained above. The first optical compensation layer and the second optical compensation layer were laminated using a commercially available acrylic pressure-sensitive adhesive (thickness: 20 μm), and the second optical compensation layer and the third optical compensation layer were laminated using an isocyanate-based curable adhesive (thickness: 5 μm). Then, the substrate (biaxially stretched PET film) supporting the third optical compensation layer was peeled, and a commercially available acrylic pressure-sensitive adhesive (thickness: 20 μm) for attaching a liquid crystal cell to the peeling surface was applied. Finally, the resultant laminate was punched to a size of 4.0 cm (longitudinal direction)×5.3 cm (lateral direction) to obtain a polarizing plate with an optical compensation layer as shown in FIG. 1.

The thickness, transmittance, heat unevenness, and heat unevenness during mounting of a liquid crystal cell of the obtained polarizing plate with an optical compensation layer were measured. Table 1 shows the results together with the results in Examples 2 to 5 and Comparative Examples 1 and 2 described later.

TABLE 1

| | | | | | | Heat unevenness during | | |
|---|---|---|---|---|---|---|---|---|
| | | | | | | mounting of liquid crystal | | |
| | | | Heat unevenness (%) | | | cell (%) | | |
| | Thickness | Transmittance | Before | After | Change | Before | After | Change |
| | (μm) | (%) | heating | heating | amount | heating | heating | amount |
| Example 1 | 262 | 0.10 | 0.21 | 1.55 | 1.34 | 0.30 | 0.39 | 0.09 |
| Example 2 | 340 | 0.10 | 7.53 | 12.18 | 4.65 | 10.65 | 17.23 | 6.58 |
| Example 3 | 262 | 0.85 | 1.22 | 2.60 | 1.38 | 1.73 | 3.68 | 1.95 |
| Example 4 | 262 | 0.85 | 1.28 | 2.70 | 1.42 | 1.81 | 3.82 | 2.01 |
| Example 5 | 340 | 0.85 | 8.02 | 12.54 | 4.52 | 11.34 | 17.74 | 6.40 |
| Comparative | 262 | 0.10 | 0.21 | 1.96 | 1.75 | 0.30 | 2.77 | 2.47 |
| Example 1 | | | | | | | | |
| Comparative | 340 | 0.10 | 7.53 | 13.61 | 6.08 | 10.65 | 19.25 | 8.60 |
| Example 2 | | | | | | | | |

### Example 2

A polarizing plate, a first optical compensation layer, and a second optical compensation layer were produced in the same way as in Example 1.

(Production of a Third Optical Compensation Layer)

A long norbornene-based resin film (Arton (trade name) manufactured by JSR, thickness: 100 μm, photoelastic coefficient: 5.00×10⁻¹² m²/N) was longitudinally stretched about 1.27 times at 175° C. and laterally stretched about 1.37 times at 176° C., whereby a long film for a third optical compensation layer (thickness: 65 μm) was produced. The film was punched to a size of 20 cm (longitudinal direction)×30 cm (lateral direction) to obtain a third optical compensation layer. An in-plane retardation Re₃ of the third optical compensation layer was 0 nm, and a thickness direction retardation Rth₃ thereof was 110 nm.

(Production of a Polarizing Plate with an Optical Compensation Layer)

A polarizing plate with an optical compensation layer was produced in the same way as in Example 1 except for using the third optical compensation layer, and laminating the second optical compensation layer and the third optical compensation layer with a commercially available acrylic pressure-sensitive adhesive (thickness: 20 μm). The thickness, transmittance, and heat unevenness of the obtained polarizing plate with an optical compensation layer were measured. The above Table 1 shows the results.

### Example 3

A polarizing plate with an optical compensation layer was produced in the same way as in Example 1, except that the slow axis of the first optical compensation layer was set to form an angle of 35° in a counterclockwise direction with respect to the absorption axis of the polarizer of the polarizing plate. The thickness, transmittance, and heat unevenness of the obtained polarizing plate with an optical compensation layer were measured. The results are shown in Table 1 above.

### Example 4

A polarizing plate with an optical compensation layer was produced in the same way as in Example 1 except that the slow axis of the second optical compensation layer was set to form an angle of 35° in a counterclockwise direction with respect to the absorption axis of the polarizer of the polarizing plate. The thickness, transmittance, and heat unevenness of the obtained polarizing plate with an optical compensation layer were measured. The results are shown in Table 1 above.

### Example 5

A polarizing plate with an optical compensation layer was produced in the same way as in Example 2 except that the slow axis of the first optical compensation layer was set to form an angle of 35° in a counterclockwise direction with respect to the absorption axis of the polarizer of the polarizing plate. The thickness, transmittance, and heat unevenness of the obtained polarizing plate with an optical compensation layer were measured. The results are shown in Table 1 above.

### Comparative Example 1

A polarizing plate with an optical compensation layer was produced in the same way as in Example 1 except for laminating the polarizing plate and the first optical compensation layer using a commercially available acrylic pressure-sensitive adhesive (thickness: 20 μm) in place of the pressure-sensitive adhesive X. The dynamic storage shear modulus (G′) at 100° C. of the acrylic pressure-sensitive adhesive used herein was measured to be 7×10⁴ Pa. The thickness, transmittance, and heat unevenness of the obtained polarizing plate with an optical compensation layer was measured. The results are shown in Table 1 above.

### Comparative Example 2

A polarizing plate with an optical compensation layer was produced in the same way as in Example 2 except for laminating the polarizing plate and the first optical compensation layer using the commercially available acrylic pressure-sensitive adhesive (thickness: 20 μm, dynamic storage shear modulus (G′) at 100° C.: 7×10⁴ Pa). The thickness, transmittance, and heat unevenness of the obtained polarizing plate with an optical compensation layer were measured. The results are shown in Table 1 above.

In Examples 1, 3, and 4 of the present invention, the degradation in optical properties were suppressed effectively irrespective of the use under a high-temperature environment. On the other hand, the optical properties in Comparative Example 1 corresponding to the configuration of the optical compensation layers of Examples 1, 3, and 4 were inferior to those in Examples 1, 3, and 4. In Examples 2 and 5 of the present invention, the degradation in optical properties were suppressed effectively irrespective of the use under a high-temperature environment. On the other hand, the optical properties in Comparative Example 2 corresponding to the configuration of the optical compensation layers of Examples 2 and 5 were inferior to those in Examples 2 and 5.

Comparing Examples 1 to 5, in Examples 1, 3, and 4 in which a cholesteric alignment fixed layer is used as the third optical compensation layer, heat unevenness exhibited a low value from an initial value in a heat unevenness test, and the degradation in optical properties were suppressed very effectively.

As is apparent from Table 1, in Examples 1 and 2, by setting the angle formed by the absorption axis of the polarizer, and the slow axes of the first optical compensation layer and the second optical compensation layer to be in a predetermined range, the transmittance in a cross-Nicols state was decreased substantially. More specifically, the light leakage in a black display was prevented satisfactorily.

### INDUSTRIAL APPLICABILITY

The polarizing plate with an optical compensation layer of the present invention can be preferably used for various kinds of image display apparatuses (for example, a liquid crystal display apparatus, a self-luminous display apparatus).

1. A polarizing plate with an optical compensation layer, comprising:
a polarizer;
a pressure-sensitive adhesive layer; and
at least one optical compensation layer, in the stated order,
wherein the pressure-sensitive adhesive layer has a dynamic storage shear modulus (G′) at 100° C. of 1.0×10⁴ to 6.0×10⁴ Pa.

2. A polarizing plate with an optical compensation layer according to claim 1, wherein:
the at least one optical compensation layer includes a first optical compensation layer, a second optical compensation layer, and a third optical compensation layer in the stated order;
the first optical compensation layer contains a resin having an absolute value of a photoelastic coefficient of 2×10⁻¹¹ m/N or less, a relationship of nx>ny=nz, and an in-plane retardation Re₁ of 200 to 300 nm;
the second optical compensation layer contains a resin having an absolute value of a photoelastic coefficient of 2×10⁻¹¹ m²/N or less, a relationship of nx>ny=nz, and an in-plane retardation Re₂ of 90 to 160 nm;
the third optical compensation layer has a relationship of nx=ny>nz, an in-plane retardation Re₃ of 0 to 20 mm, and a thickness direction retardation Rth₃ of 30 to 300 nm; and
an angle formed by an absorption axis of the polarizer and a slow axis of the first optical compensation layer is 10 to 30°, and an angle formed by the absorption axis of the polarizer and a slow axis of the second optical compensation layer is 70 to 90°.

3. A polarizing plate with an optical compensation layer according to claim 2, wherein the pressure-sensitive adhesive layer is provided between the polarizer and the first optical compensation layer.

4. A polarizing plate with an optical compensation layer according to claim 2, wherein the third optical compensation layer has a thickness of 1 to 50 μm.

5. A polarizing plate with an optical compensation layer according to claim 2, wherein the third optical compensation layer is formed of a cholesteric alignment fixed layer having a selective reflection wavelength region of 350 nm or less.

6. A polarizing plate with an optical compensation layer according to claim 2, wherein the third optical compensation layer includes a layer formed of a film having a relationship of nx=ny>nz and containing a resin having an absolute value of a photoelastic coefficient of 2×10⁻¹¹ m²/N or less, and a cholesteric alignment fixed layer having a selective reflection wavelength region of 350 nm or less.

7. A polarizing plate with an optical compensation layer according to claim 1, wherein the pressure-sensitive adhesive layer is formed of an acrylic pressure-sensitive adhesive.

8. A polarizing plate with an optical compensation layer according to claim 7, wherein:
the acrylic pressure-sensitive adhesive contains a (meth)acrylic polymer (A) obtained by copolymerizing 0.01 to 5 parts by weight of a hydroxyl group-containing (meth)acrylic monomer (a2) with respect to 100 parts by weight of alkyl(meth)acrylate (a1), a peroxide (B), and an isocyanate-based compound (C);
the peroxide (B) is blended in an amount of 0.02 to 2 parts by weight with respect to 100 parts by weight of the (meth)acrylic polymer (A); and
the isocyanate-based compound (C) is blended in an amount of 0.001 to 2 parts by weight with respect to 100 parts by weight of the (meth)acrylic polymer (A).

9. A liquid crystal panel, comprising:
the polarizing plate with an optical compensation layer according to claim 1; and
a liquid crystal cell.

10. A liquid crystal panel according to claim 9, wherein the liquid crystal cell is a reflection-type or a semi-transmission-type liquid crystal cell of a VA mode.

11. A liquid crystal display apparatus, comprising the liquid crystal panel according to claim 9.

12. An image display apparatus, comprising the polarizing plate with an optical compensation layer according to claim 1.
